(19) United States
(12) Patent Application Publication
(10) Pub. No.: US 2018/0225537 A1
(43) Pub. Date: Aug. 9, 2018

(54) METHODS AND APPARATUS RELATING TO CAMERA SWITCHING AND/OR MAKING A DECISION TO SWITCH BETWEEN CAMERAS

(71) Applicant: NextVR Inc., Newport Beach, CA (US)

(72) Inventors: David Cole, Laguna Beach, CA (US); Alan McKay Moss, Laguna Beach, CA (US)

(21) Appl. No.: 15/892,412

(22) Filed: Feb. 9, 2018

Related U.S. Application Data
(63) Continuation-in-part of application No. 15/892,405, filed on Feb. 8, 2018.
(60) Provisional application No. 62/456,657, filed on Feb. 8, 2017.

(51) Int. Cl. G06K 9/32; H04N 5/268; G06K 9/00; G06T 7/20

(52) U.S. Cl. CPC G06K 9/3233; H04N 5/268; H04N 7/181; G06T 7/20; G06T 2207/20104; G06K 9/00771

(57) ABSTRACT

In order to reduce or minimize the effect of camera switching performed outside of user control in some embodiments an automated camera switching policy policing system is implemented. The policing system can make camera switch recommendations, automatically implement camera switches and/or take other actions. In some embodiments the automated policing system tracks the location of an area of interest in the environment, e.g., an area corresponding to the location of an object of interest, where images are being captured. Camera switches are recommend when the object of interest remains in the field of view of a current camera supplying content and the field of view of a camera to which a switch is to be made. Recommendations are made against camera switches which will result in a switch which will prevent a user from viewing the same object of interest before and after a camera switch.

### RELATED APPLICATIONS

The present application claims the benefit of U.S. Provisional Patent Application Ser. No. 62/456,657 filed Feb. 8, 2017 which is hereby expressly incorporated by reference in its entirety

### FIELD

The present application relates to methods and apparatus which facilitate preserving a viewer's point of view and/or keeping an object in view in a system where a switch maybe made between cameras providing content for presentation.

### BACKGROUND

Many times during events taking place at environments such as sports stadiums, theaters, concert halls, the events are captured by a number of cameras placed at different locations to capture a different perspective of the event that is taking place. Some times the cameras are placed in the vicinity of the actual seating areas for the audience so that the content presented to the users is captured from the perspective of audience actually experiencing the event. For example during a sporting event such as a soccer game in a sports arena/stadium, multiple cameras are deployed at different locations, for example with one or more cameras close to the mid field position corresponding to the halfway line in the center of the field, one or more cameras close to each corner of the field and one or more cameras near the end lines of the field corresponding to the two goal post. Each of the deployed cameras capture content from the perspective of its camera position.

Cameras at different camera positions may have different default points of view, e.g., default portions of a environment which are captured. While a camera may have a default view, while viewing images corresponding to a particular camera a user may have turned his and/or her head and have a user point of view of the environment which is different from the default point of view of a camera supplying the content being viewed.

As players, actors or other elements of interest, sometimes referred to as objects of interest, move in the environment, they may become more distant from one camera than another. A producer or user may choose to switch between which camera is used as the source of content being viewed by a user in response to changes in the location of action or for other reasons.

In the case of cameras using fish eye lens that are sometimes used to support 3D image capture, it maybe important to switch from one camera to another as a ball or other object of interest moves down the field since as the object moves towards the end of the field of view the image capture often becomes more distorted than when the object is captured using the portion of the lens corresponding to the center portion of the fish eye lens. Thus, in cases where fish eye lenses are used for image capture the need to switch between cameras can be even greater than in other systems which such lenses are not used. Regardless of the type of lens used, there is still a need in many cases to support switching between which camera is used for image content to be streamed to a playback device.

A switch between cameras supplying images to a viewer may result in a user looking at one point in an environment at one moment and then suddenly looking at another point in the environment particularly if the switch is between first and second cameras which do not have an overlapping field of view. Such a switch, particularly in a simulated environment, can be traumatic to a user since the user's perceived viewing position can suddenly change from one camera location to another. This can give the user a strange sense of suddenly changing positions in the environment being viewed. This strangeness can be complicated by not only the fact that the camera from which images are being supplied is at a different location in the environment where images are being captured but also due to the fact that the camera to which the image feed is switched may have a different default view of the environment than the camera which was previously being used to capture and supply images.

In view of the above discussion it should be appreciated that there is a need for methods and/or apparatus which can reduce or minimize the potentially disorienting and/or unsettling feeling that switching between camera at different locations in an environment may have an a user viewing images of the environment, e.g., as part of a stereoscopic or non-stereoscopic environmental simulation.

It would be desirable if at least some features were directed to reducing or minimizing disorienting camera switches and/or the disorientation to a user that will occur when there is a switch. In particular, there is a need for methods and/or apparatus which can be used in controlling camera switching, e.g., which camera serves as a source of content to a user. For example it would be desirable if one or more features could be developed which would reduce the risk of switching between cameras that do not have an object of interest in their field of view when a switch is made and/or which allow a switch to be made with the user being able to see the same object of interest both before and after a switch to reduce the disorientation that might otherwise result, e.g., from an object of interest disappearing from view at the time of the camera switch.

There is also a need for methods and apparatus that can be used in a playback device receiving content captured by one or more cameras in an environment to reduce or minimize the effect of a camera switch on a user's point of view. In particular it would be desirable if methods and/or apparatus could be developed which would allow a user viewing an object of interest in an environment to still be looking at the same object after a camera switch which may have been implemented.

From the above it should be appreciated that from the production and/or transmission side it would be desirable if methods and/or apparatus could be developed that could reduce or avoid the risk of disorienting and/or unsettling switches between cameras supplying image content to one or more playback device, e.g., playback devices which are used to provide the user with an experience of being in the environment. For the playback side it would be desirable if methods or apparatus could be developed which allow or minimize the impact of camera switches on the viewer, e.g., with in some but not all embodiments the playback device working to maintain or minimize the change to a user's point of view in the environment when a camera switch occurs.

### SUMMARY

Methods and apparatus which facilitate preserving a viewer's point of view and/or keeping an object in view in a system where a switch maybe made between cameras providing content for presentation are described. One or more features of the methods can be used to minimize or reduce the effect of camera switches on a viewer.

In various embodiments the viewer views displayed images of an environment where the images are captured. The displayed images maybe and sometimes are generated using a rendering process which involves using a captured image or images as a texture and applying it to a surface of a model of the environment to generate a rendered image which is then displayed to the user of a playback device which receives image content and displays it to the user. By displaying left and right eye images to a user's left and right eyes, respectively, a stereoscopic playback is achieved in some embodiments.

In some embodiments captured images are used as textures that are applied to a surface of a model of an environment in accordance with a texture map or texture maps. A texture map indicates how an image or images of the environment captured by a camera and which are provided to the playback device are to be applied to a surface of the model of the environment as part of a rendering operation that is used generate a rendered image that is then displayed to a user of the playback device. While a single model of the environment maybe used for images captured by different cameras, the location of an individual camera is known in or relative to the environment in which the images to be rendered are captured. Camera location is taken into consideration when using the model of the environment during rendering in at least some embodiments.

Some but not necessarily all embodiments support a stereoscopic viewing experience where a user at a playback location such as his home, is provided with a sense of being in the real world environment, e.g., stadium, where images are captured. In such a playback system, when a camera switch is made, the user will often have the sense of switching from one location to another in the 3D environment as if they were teleported from the viewing location corresponding to the first camera location to the viewing location of a second camera to which a switch is made.

In some embodiments switching between what camera serves as the source of image content supplied to a user, e.g., of a playback device, is controlled during production or in the network, e.g., by an operator of a streaming server or automatically by the streaming server. Thus while the images of multiple cameras, e.g., sometimes referred to as camera feeds, maybe received and encoded by a content delivery system including a streaming server, which camera is used to supply content to one or more playback systems can change based on operator control and/or automatically based on streaming server monitoring one or more things including but not limited to the location of an object of interest in the environment and/or input form one or more viewers in the environment which can and sometimes do provide real time head tracking or viewing information which can then be used to decide which camera feed to provide to the playback devices, e.g., which the event is on going.

The operator of the streaming server is sometimes referred to as a producer since the operator control production of the content stream or streams to be supplied to playback devices. During a sports game the producer may control switching between which cameras in a stadium are used to supply video content to the playback device. In such a case, a user may not be expecting a switch between cameras.

In order to reduce or minimize the effect of camera switches performed outside of user control, e.g., on the production or network side of an image distribution system, in some embodiments an automated camera switching policy policing system is implemented. The policing system can make camera switch recommendations, automatically implement camera switches and/or take other actions.

In some embodiments the automated policing system tracks the location of an area of interest in the environment, e.g., an are corresponding to the location of an object of interest, where images are being captured. The area of interest maybe the location of an object such as a ball, a location of action, the location of an individual or area of interest determined through director and/or viewer input, e.g., the area in the environment where a group of viewers are looking. As the area of interest, e.g., area corresponding to a ball, player, actor, musician, etc. moves from one location in the environment to another the location of the area of interest is updated.

The location of the area of interest is compared to sets of camera coverage areas sometimes arranged as one or more sets of locations, corresponding to locations within the field of view of one or more cameras, to determine one or more of: a camera switching recommendation, e.g., a recommendation that camera switching should occur or should not occur based on location of the point of interest and/or the direction in which the point of interest has been moving; an automated camera switching operation; and/or a prohibition on camera switching.

In some but not necessarily all embodiments, a recommendation to switch between cameras maybe and sometimes is automatically made, and/or an automatic prohibition on switching between cameras maybe and sometimes is made, when a camera switch would result in a camera change which would result in a change from a camera with a field of view that includes the point of interest to a camera with a field of view which does not include the point of interest. Thus a producer or director who decides to implement a camera switch during a sporting event, e.g., in real or near real time, maybe advised against a camera switch or precluded from making a camera switch in some cases, e.g., when such a switch would result in the point of interest being outside the view of the camera to which the switch would be made.

While in some cases a switch maybe advised against or automatically prevented, in other cases a switch between cameras maybe and sometimes is automatically recommended or implemented based on the position and/or direction of movement of the area of interest. For example, as the area of interest is moving away from the center of the field of view of a first camera towards a region covered by a second camera, a recommendation maybe made an operator of the image capture and/or processing system to switch from the first camera to the second camera at a point while the location of interest is still in the field of view of both the first and second cameras. In the case where the switch is not implemented following the recommendation and the location of the area of interest is determined to be outside or almost outside the field of view of the first camera, an automatic camera switch maybe implemented. In other embodiments where switch recommendations are not made to an operator, the system switching is fully automated, largely automated or set to an automated switching mode of operation, automated switching between cameras may occur without first providing a camera switch recommendation to an operator. In such a case switching between first and second cameras may occur while the area of interest remains within the field of view of the first and second cameras without waiting for the area of interest to approach or reach the edge of the field of view of the first camera while the area of interest is within an area covered by both the field of view of the first camera and the second camera.

By taking direction of motion into consideration along with object position, camera switching points can be optimized with the switching between first and second cameras being motion as well as position dependent. Thus the switching point for switching between first and second cameras can be, and sometimes is, different when the area and/or object of interest is moving in different directions.

While various features relate to recommending when camera switching should occur or controlling when camera switching automatically happens, various playback device features relate to maintaining a user's point of view, e.g., maintain a view of the same surface or object when possible, when came switching occurs. Thus while maintaining the exact same point of view may not be possible due to the difference in camera locations maintaining a point of view for purposes of the present invention is to be understood to include maintaining a users view of a surface or object being viewed prior to a camera switch. The surface maybe and sometimes is the surface of a ball or other object.

In at least some but not necessarily all embodiments, a user of a playback device is presented with images of an environment captured by a second camera after being presented with images captured by a first camera where the first and second cameras are at a different locations in the environment.

In various embodiments, in the playback device, a user's point of view at the time of a switch between cameras which are being used as the source of content is taken into consideration. Also taken into consideration in some but not necessarily all embodiments is the difference, if any, between default camera viewing positions in the environment between the camera from which a switch is being made and a camera which is becoming the new content source. The distance from the different cameras to the object being viewed at the time of the switch is also taken into consideration in some but not necessarily all embodiments.

When a switch between which camera in an environment and thus the camera supplying the content feed to the playback device via the content delivery system changes, the playback device rendering and providing the content to a display takes into consideration what the user's point of view was at the time of switch and preserves the user's point of view so that the user is looking at the same portion, e.g., object in the environment, after the switch from images captured by a first camera to images captured by a second camera. This involves in at least some embodiments use of a model of the environment by the playback device and information about the position of the first and second cameras in the environment which are taken into consideration by the playback device to decide which portion of the environment to display to a user after a camera switch, e.g., based in some but not necessarily all embodiments on the playback device user's head position.

Thus, despite the difference in the locations in the cameras in the environment where the images are captured, a user will have a sense, after the switch, of looking at the same object that was being viewed before the switch but from the location of the second camera rather than the first camera. User's of different playback devices may and sometimes will have different views do to their different head positions at the time of the switch. While this may not totally avoid the disorienting affect of the switch on a user of a playback device, it results in a less disorienting switch than might otherwise be the case.

In many embodiments the cameras are stereoscopic cameras where a stereoscopic camera maybe and sometimes is implemented as a pair of individual cameras, e.g., a left eye camera and a right eye camera. Thus while the term stereoscopic camera is used it should be appreciated that a stereoscopic camera can be implemented as a pair of individual cameras mounted to capture left and right eye views or two cameras including in a single device or housing. Individual cameras of a stereoscopic camera pair are sometimes referred to as a left eye camera and a right eye camera.

While the methods are well suited for stereoscopic applications they can also be used where images are captured using individual cameras and switching between which camera is used to supply image may occur. Thus it should be appreciated that the methods and apparatus are not limited to stereoscopic applications.

While numerous features are discussed in the summary it should be appreciated that many of the features can be used independently. Accordingly, Applicant does not intend to imply by mentioning a feature in this summary that the feature is necessary or critical to all embodiments or that is included in all embodiments.

Numerous variations on the above described methods and apparatus are possible. The methods and apparatus and various benefits are discussed further in the detailed description which follows.

### BRIEF DESCRIPTION OF THE FIGURES

FIG. 1 illustrates an exemplary system implemented in accordance with some embodiments of the invention which can be used to capture and stream content for subsequent display by one or more users along with one or more synthesized portions of an environment.

FIG. 2 illustrates an exemplary rendering and playback system, e.g., 3D rendering and playback system, implemented in accordance with one exemplary embodiment of the invention.

FIG. 3 illustrates another exemplary rendering and playback system implemented in accordance with some other embodiments of the invention.

FIG. 4 is a drawing illustrating a view of an exemplary environment, e.g., a stadium, theater, sports field, etc., or a similar platform, including cameras located at various positions to capture an event, said cameras being in their default orientations.

FIG. 5 is a drawing showing the environment including the cameras of FIG. 4 being set to director controlled orientations.

FIG. 6 illustrates a determined user point of view in the environment for an example in which the user's head has been rotated from a straight ahead position and the head mounted device is outputting image data captured by the first camera.

FIG. 7 illustrates an example in which the headmounted rendering and playback device receives a switch signal indicating a switch from the first camera to the second camera.

FIG. 8 illustrates the headmounted rendering and playback device displaying, following the switch, content captured by the second camera device, said image content displayed following the switch including content corresponding to the a same identified location in the environment as was displayed before the switch.

FIG. 9 is a drawing illustrating an exemplary display and displayed content for a headmounted display before and after a switch from a first camera to a second camera in accordance with an exemplary embodiment.

FIG. 10A is a first part of a flowchart of an exemplary method of operating a rendering and playback system in accordance with an exemplary embodiment.

FIG. 10B is a second part of a flowchart of an exemplary method of operating a rendering and playback system in accordance with an exemplary embodiment.

FIG. 10 comprises the combination of FIG. 10A and FIG. 10B.

FIG. 11 illustrates an exemplary content delivery system that can be used to encode and stream content in accordance with the features of the invention.

FIG. 12 illustrates an exemplary rendering and playback system that can be used to receive, decode and display the content streamed by the system of FIG. 11.

FIG. 13A is a first part of an assembly of components which may be including in a rendering and playback system in accordance with an exemplary embodiment.

FIG. 13B is a second part of an assembly of components which may be including in a rendering and playback system in accordance with an exemplary embodiment.

FIG. 13 comprises the combination of FIG. 13A and FIG. 13B.

FIG. 14 is a drawing of exemplary data/information which may be included in an exemplary rendering and playback system in accordance with an exemplary embodiment.

FIG. 15A is a first part of a flowchart of an exemplary method of operating a system, e.g., a content delivery system, in accordance with an exemplary embodiment.

FIG. 15B is a second part of a flowchart of an exemplary method of operating a system, e.g., a content delivery system, in accordance with an exemplary embodiment.

FIG. 15C is a third part of a flowchart of an exemplary method of operating a system, e.g., a content delivery system, in accordance with an exemplary embodiment.

FIG. 15D is a fourth part of a flowchart of an exemplary method of operating a system, e.g., a content delivery system, in accordance with an exemplary embodiment.

FIG. 15 comprises the combination of FIG. 15A, FIG. 15B, FIG. 15C and FIG. 15D.

FIG. 16A is a first part of an assembly of components which may be including in a system, e.g., a content delivery system, in accordance with an exemplary embodiment.

FIG. 16B is a second part of an assembly of components which may be including in a system, e.g., a content delivery system, in accordance with an exemplary embodiment.

FIG. 16C is a third part of an assembly of components which may be including in a system, e.g., a content delivery system, in accordance with an exemplary embodiment.

FIG. 16A is a fourth part of an assembly of components which may be including in a system, e.g., a content delivery system, in accordance with an exemplary embodiment.

FIG. 16 comprises the combination of FIG. 16A, FIG. 16B, FIG. 16C and FIG. 16D.

FIG. 17 is a drawing of exemplary data/information which may be included in an exemplary system, e.g., a content delivery system, in accordance with an exemplary embodiment.

FIG. 18 is a drawing illustrating an environment including a plurality of cameras and a plurality of headmounted monitoring devices for obtaining live viewer head orientation information to be used in camera switching decisions, and an object of interest, in accordance with an exemplary embodiment.

FIG. 19 shows an exemplary mesh model 1900 of an environment which can be used in various embodiments.

FIG. 20 shows an image captured by a camera with a UV map in the form of a grid superimposed thereon

FIG. 21 is an diagram showing how left and right eye views captured by cameras of different stereoscopic pairs directed towards different portions of the environment can be applied to corresponding portions of the 3D mesh model of the environment shown in FIG. 19.

### DETAILED DESCRIPTION

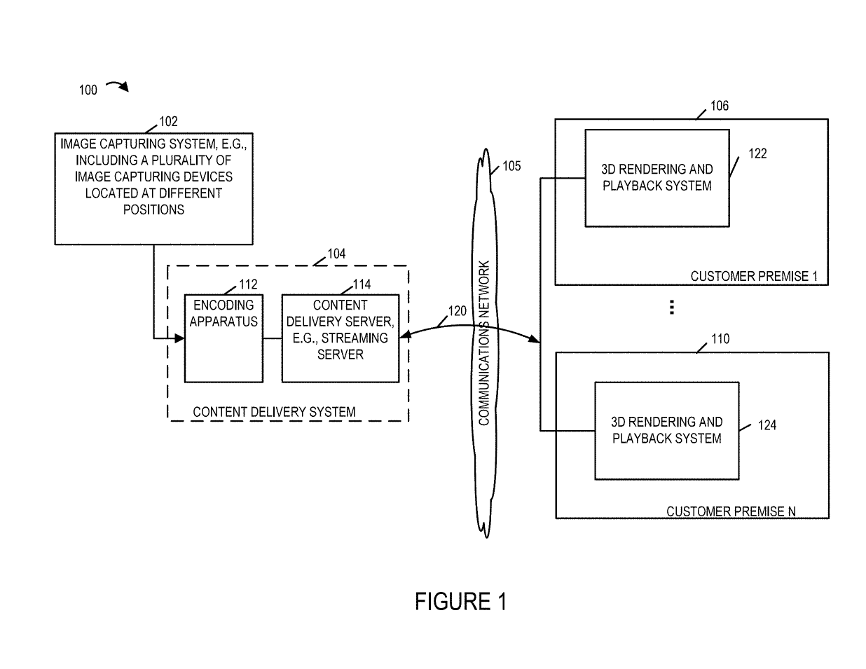

FIG. 1 illustrates an exemplary system 100 implemented in accordance with some embodiments of the invention. The system 100 supports content delivery, e.g., imaging content delivery, to one or more customer devices, e.g., 3D capable playback devices located at customer premises. The system 100 includes the exemplary image capturing system 102, a content delivery system 104, a communications network 105, and a plurality of customer premises 106, . . . , 110. The image capturing system 102 supports capturing of stereoscopic imagery, e.g., using stereoscopic camera pairs, as well as capturing of normal non-stereoscopic imagery. However, the system is not limited to stereoscopic applications and can be used in system which capture a single view an environment as opposed to left and right eye views as well.

The image capturing system 102 captures and processes imaging content in accordance with the features of the invention and may include a plurality of cameras/stereoscopic camera pairs corresponding to different camera positions in an environment for capturing images. The communications network 105 may be, e.g., a hybrid fiber-coaxial (HFC) network, satellite network, and/or internet.

The content delivery system 104 includes an encoding apparatus 112 and a content streaming device/server 114. The encoding apparatus 112 may, and in some embodiments does, include one or a plurality of encoders for encoding image data. The encoders may be used in parallel to encode different portions of a scene and/or to encode a given portion of a scene to generate encoded versions which have different data rates. Using multiple encoders in parallel can be particularly useful when real time or near real time streaming is to be supported. In some embodiments multiple different encoders are used in parallel to encode streams captured by different camera devices placed at different camera positions to capture images to allow the streaming device 114 to stream content corresponding to different camera positions based in a user selection.

The content streaming device 114 is configured to stream, e.g., transmit, encoded content for delivering the encoded image content to one or more customer devices, e.g., over the communications network 105. The content streaming device 114 may and in some embodiments does stream or make available for streaming content corresponding to multiple cameras in the environment allowing the playback device to selected between the content streams, e.g., based on user input. In other embodiments the content streaming server 114, streams content from a camera device selected by a operator of the content delivery system who is sometimes referred to as a director or automatically determines the content to stream at a given time. In at least some such embodiments a decision to switch between first and second cameras in an environment will result in a switch from streaming content from the first camera to streaming content from the second camera. Thus in such an embodiment the content delivery system and operator thereof will control which camera feed is used to supply content to playback devices 122, 124 at a given time.

Via the network 105, the content delivery system 104 can send and/or exchange information with the devices located at the customer premises 106, 110 as indicated in the figure by the link 120 traversing the communications network 105. While the encoding apparatus 112 and content delivery server are shown as separate physical devices in the FIG. 1 example, in some embodiments they are implemented as a single device which encodes and streams content. The encoding process may be a 3D, e.g., stereoscopic, image encoding process where information corresponding to left and right eye views of a scene portion are encoded and included in the encoded image data so that 3D image viewing can be supported. The particular encoding method used is not critical to the present application and a wide range of encoders may be used as or to implement the encoding apparatus 112.

Each customer premise 106, 110 may include one or more devices/systems, e.g., devices capable of decoding, rendering, playback and display of the imaging content streamed by the content streaming device 114. Customer premise 1 106 includes a 3D rendering and playback system 122 while customer premise N 110 includes 3D rendering and playback system 124. While systems 122 are refereed to as rendering and playback systems in other locations in this application they are simply referred to as playback systems since the rendering is performed in many embodiments as part of playing back content. In some embodiments the 3D rendering and playback systems 122, 124 are capable of rendering and displaying 3D imaging content in accordance with the invention.

In various embodiments the 3D rendering and playback systems 122, 124 may decode the imaging content received from the content delivery system 104, generate imaging content using the decoded content, and render the imaging content, e.g., 3D image content, on a display e.g., a stereoscopic display. In various embodiments the 3D rendering and playback systems 122, 124 are capable of performing additional processing, e.g., tracking user's head position and/or line of sight to determine which camera position the user wants to view the environment from and accordingly switch to displaying in accordance with the features of the invention.

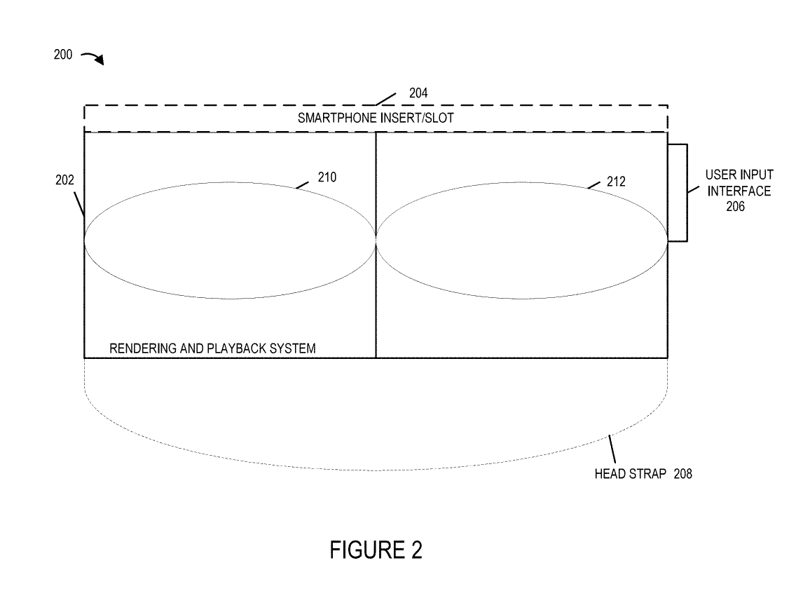

FIG. 2 illustrates an exemplary 3D rendering and playback system, implemented in accordance with one exemplary embodiment of the invention. The exemplary 3D rendering and playback system 200 may be used to display content captured by one or multiple cameras of the imaging system 102 and streamed by the content delivery system 104 to a user, e.g., a customer corresponding to customer premises 106, 110, in accordance with one exemplary embodiment. The exemplary 3D rendering and playback system 200 may be used as any of the 3D rendering and playback systems shown in FIG. 1. FIG. 2 shows a rear view of the 3D rendering and playback system 200 from the perspective of a user as if the user is going to wear, e.g., head mount, the rendering and playback system 200. Thus the illustrated view in FIG. 2 shows at least some elements that may be visible from the rear, e.g., looking into the rendering system 200 from the rear. The exemplary 3D rendering and playback system 200 includes a head mounted display assembly 202, a Smartphone insert/slot 204, a user input interface 206, a pair of lenses 210, 212 and a head strap 208.

Via the Smartphone insert/slot 204, a Smartphone can be inserted in the head mounted display assembly 202 of the system 200 thereby allowing the Smartphone display to become the display of the system 200. Once inserted in the slot 204 the Smartphone can communicate and exchange signaling with the head mounted display assembly 202. The Smartphone insert/slot 204 is shown as a dashed rectangular box to indicate the location of the slot 204 in the top portion of the rendering and playback system 200. The Smartphone serves as both the rendering and playback device, e.g., performing processing, rendering, playback and various operations for the system 200, and as the display device of the system 200 with the Smartphone screen serving as the display screen of the system 200. When mounted by a user, the user can view a displayed scene, e.g., a simulated 3D environment including content corresponding to a scene, through the lenses 210, 212. The simulated 3D environment displayed to the user allows for a real life 3D experience as if the user is actually present in the simulated environment.

Via the user input interface 206 user input is detected and actions are taken by the rendering and playback system 200. In some embodiments the user input interface 106 includes a touchpad over which the user can move his fingers and a corresponding pointer, visible to the user on the display screen, moves along allowing the user to interact with objects displayed on the screen.

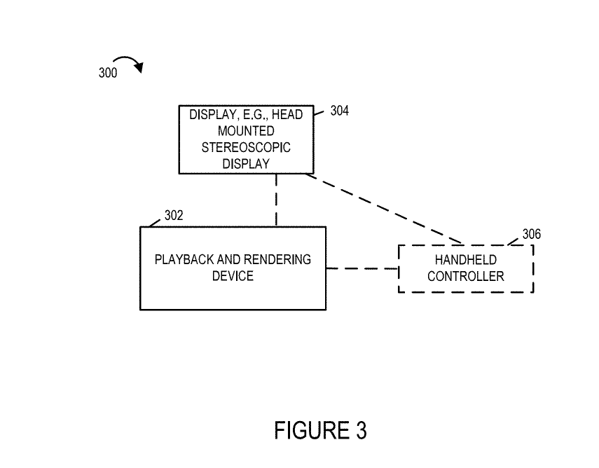

FIG. 3 illustrates another rendering and playback system 300 implemented in accordance with some embodiments of the invention. The rendering and playback system 300 may be used as any of the exemplary 3D rendering and playback systems shown in FIG. 1. The rendering and playback system 300 maybe used to implement the methods of the present invention and present content to a user from the perspective of a user desired camera position. The exemplary 3D rendering and playback system 300 includes a playback and rendering device 302, e.g., a gaming console such as PS3, PS4 or other play station version, an Xbox version etc. In addition the rendering and playback system 300 further includes a stereoscopic display 304, and optionally a handheld controller 306. The elements 302, 304 and 306 of the system 300 may be wired and/or wirelessly connected (e.g., dashed lines indicating wired and/or wirelessly links). The display 304 in some embodiments is a head mounted stereoscopic display while in some other embodiments the display 304 may be another display device capable of displaying stereoscopic imaging content. In some embodiments the head mounted stereoscopic display 304 includes one or more sensors configured to track user's head movement and/or detect a change in user's head position. In some embodiments the playback and rendering device 202 includes one or more sensors, e.g., cameras, track user's head movement and/or detect a change in user's head position.

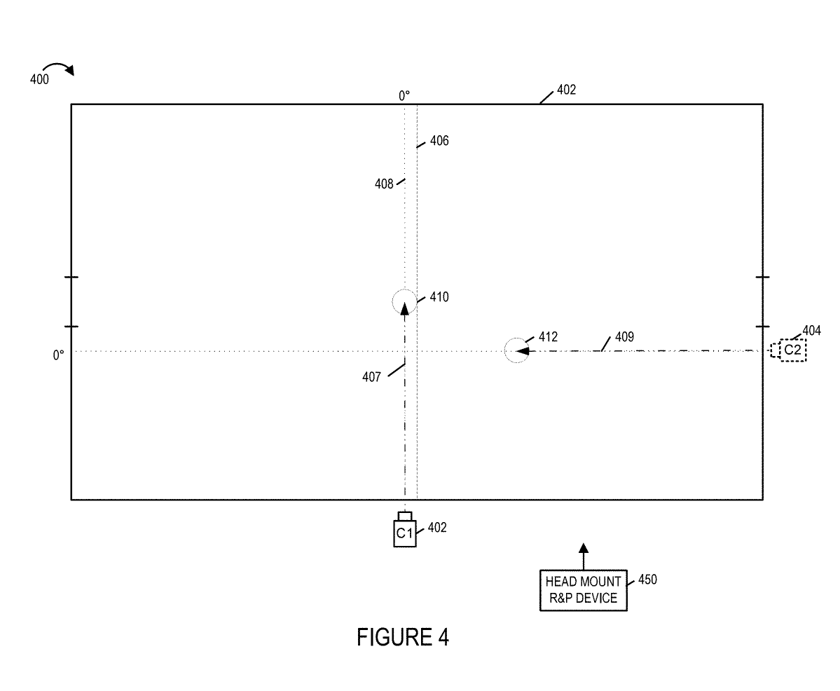

FIG. 4 is a drawing 400 illustrating a view of an exemplary environment, e.g., a stadium, theater, sports field, etc., or a similar platform, including cameras (camera C1 402, camera C2 404) located at various positions to capture an event, said cameras 402, 404 being in their default orientations. FIG. 4 further includes a headmounted rendering and playback (R & P) device 450, which may, and sometimes does receive content streams from cameras C1 402 and C2 404 and display image content. FIG. 4 is a top down view, e.g., looking down on a portion of the environment which shows the camera and a ground area, e.g., a playing field. 0 degree reference line 408 is shown. In various embodiments, cameras C1 402 and camera C2 404 each include a fisheye lens. Consider that for camera 1 402 the default orientation results in a point of view 407 directed toward location 410 along line 408. Consider that for camera 2 404 the default orientation results a point of view 409 directed toward location 412. Headmounted rendering and playback device 450, can and sometimes does display selected content captured from a camera based on the current orientation of the headmounted rendering and playback device. In one embodiment, when the headmounted rendering and playback device 450 is level and forward looking, e.g., untilted and unrotated, and displaying content captured from camera 1 402, the headmounted rendering and playback device 450 may, and sometimes does, display image content corresponding to location 410 on the center of a display area. In one embodiment, when the headmounted rendering and playback device 450 is level and forward looking, e.g., untilted and unrotated, and displaying content captured from camera 2 404, the headmounted rendering and playback device 450 may, and sometimes does, display image content corresponding to location 412 on the center of a display area.

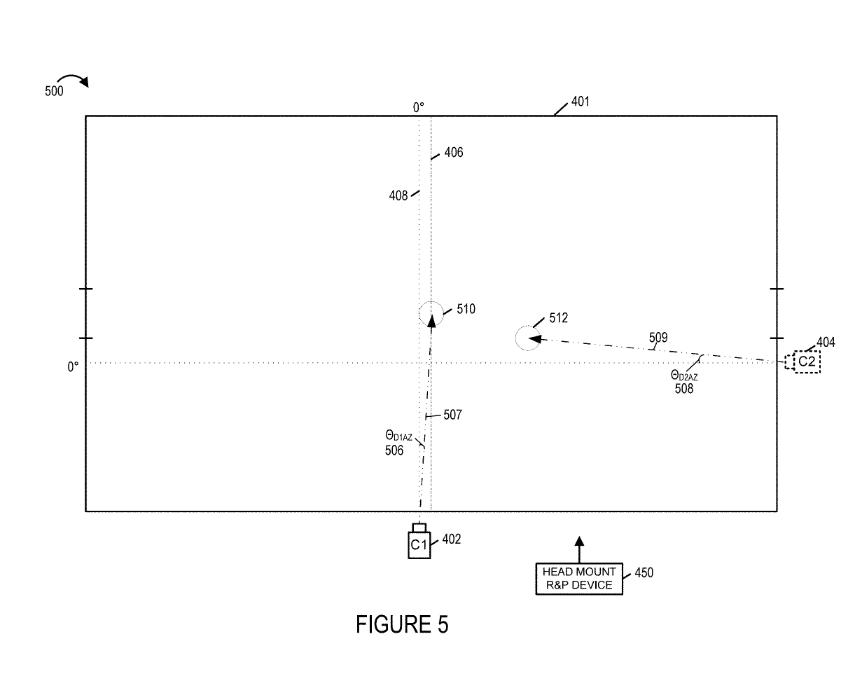

FIG. 5 is a drawing 500 showing the environment including the cameras 402, 404 of FIG. 4 being set, e.g., rotated, to achieve desired director controlled orientations. Camera C1402 is oriented in a director controlled orientation with an azimuth angle offset θD_{1AZ} 506, with respect to the default orientation shown in FIG. 4. Camera C2404 is oriented in a director controlled orientation with an azimuth angle offset θD_{2AZ} 508, with respect to the default orientation shown in FIG. 4. Consider that for camera 1 402 the director specified orientation results in a point of view 507 directed toward location 510. Location 510 occurs on line 406. Consider that for camera 2 404 the director specified orientation results a point of view 509 directed toward location 512.

In one embodiment, when the headmounted rendering and playback device 450 is level and forward looking, e.g., untilted and unrotated, and displaying content captured from camera 1 402, the headmounted rendering and playback device 450 may, and sometimes does, display image content corresponding to location 510 on the center of a display area. In one embodiment, when the headmounted rendering and playback device 450 is level and forward looking, e.g., untilted and unrotated, and displaying content captured from camera 2 404, the headmounted rendering and playback device 450 may, and sometimes does, display image content corresponding to location 512 on the center of a display area. It should be noted that location 510 is shifted from location 410, and that location 512 is shifted from location 412.

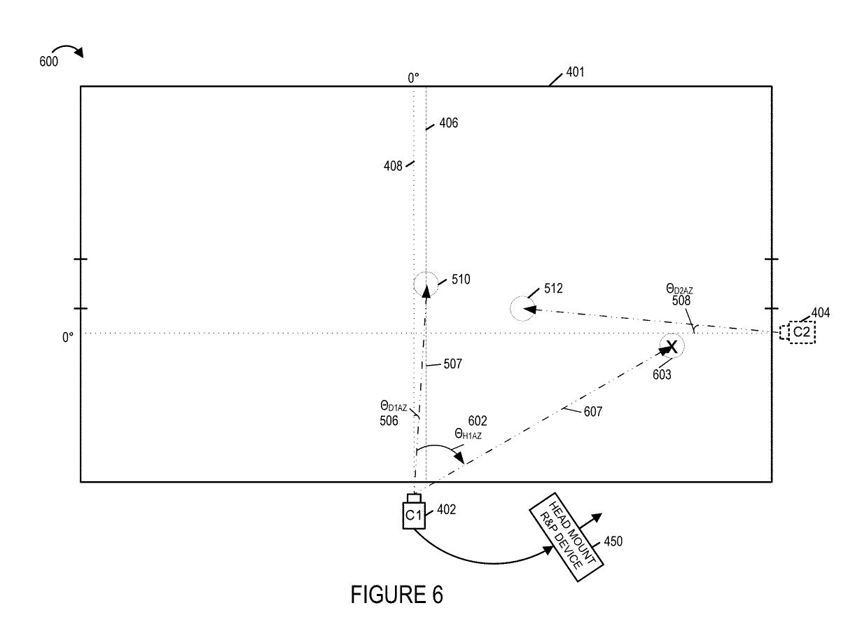

FIG. 6 includes drawing 600 illustrating a determined user point of view 607 in the environment for an example in which the user's head, on which device 450 is mounted, has been rotated from a straight ahead and level position, and the head mounted device 450 is outputting image data captured by the first camera C1 402, as a function of the determined first camera point of view 507 and the headmount orientation. Consider that the headmounted device 450 has been rotated by an azimuth angle offset θ_{H1AZ} 506, from the straight ahead looking position and the users head is slightly tilted up from the nominal level position, resulting in user point of view 607; the headmounted rendering and playback device 450 displays image content corresponding to location 603 on the center of a display area.

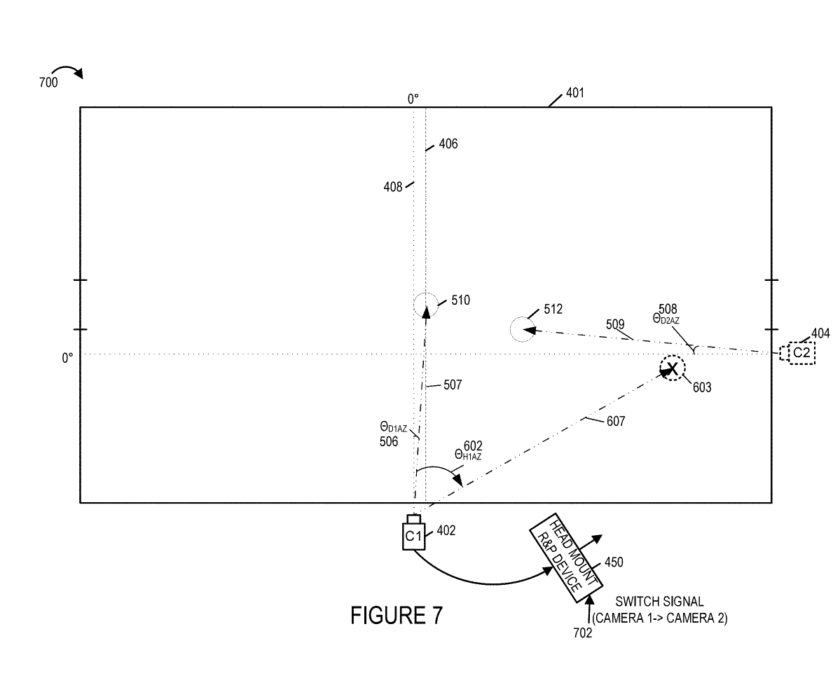

FIG. 7 is a drawing 700 illustrating an example, in which the headmounted rendering and playback device 450, which has been displaying content in accordance with FIG. 6, receives a switch signal 702 indicating a switch from the first camera C1 402 to the second camera C2 404. The rendering and playback device 450 determines a first user point of view which is point of view 607, and identifies a location, location 603 on a model of the environment corresponding to the first user point of view 607.

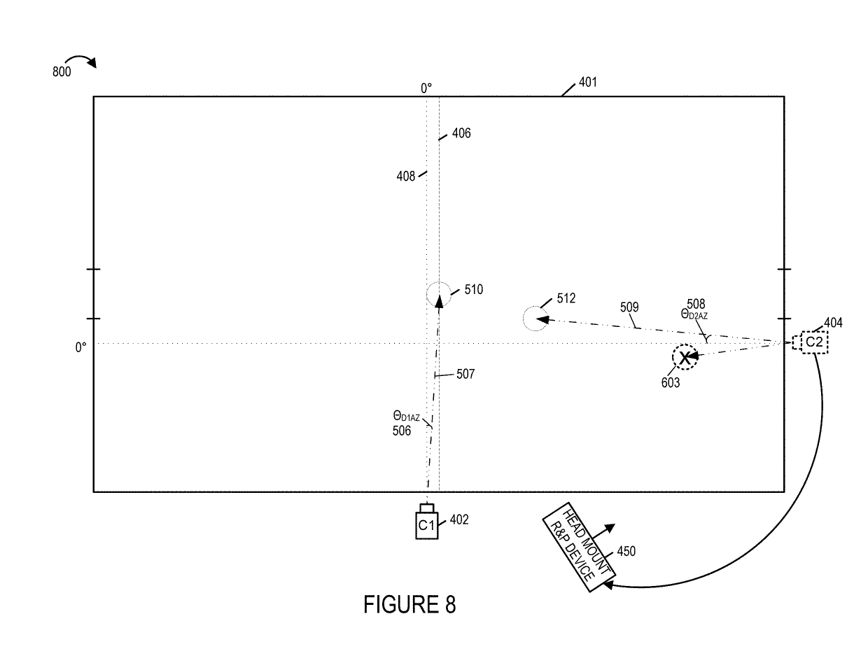

FIG. 8 is a drawing 800 illustrates the headmounted rendering and playback device 450 displaying, following the switch in response to the switch signal of FIG. 7, content captured by the second camera device 404, said image content displayed following the switch including content corresponding to the a same identified location 603 in the environment as was displayed before the switch.

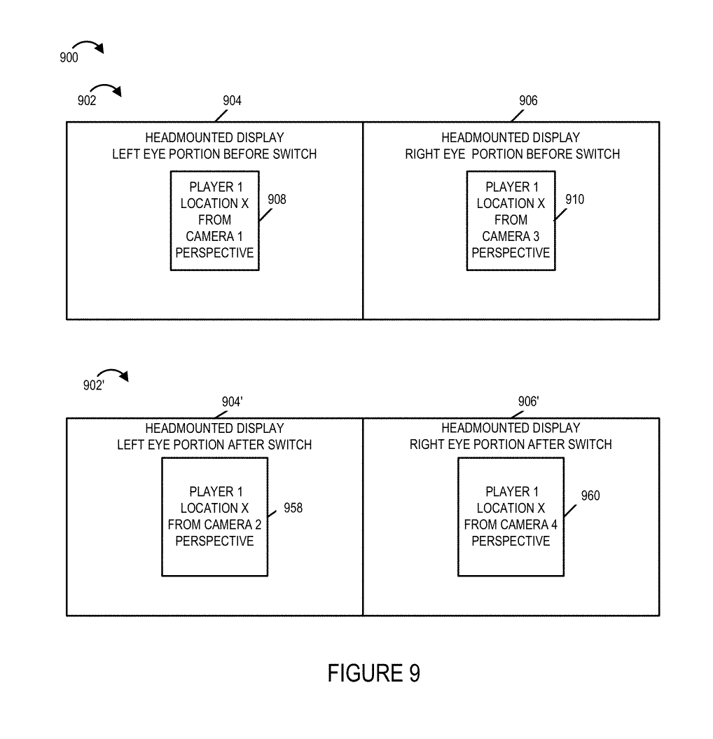

FIG. 9 is a drawing 900 illustrating an exemplary display and displayed content for a headmounted rendering and display device before and after a switch from a first camera, e.g., camera C1 401 to a second camera, e.g., camera C2 402, in accordance with an exemplary embodiment. In the example of FIG. 9, the environment includes stereoscopic camera pairs, instead of just single cameras at each location. Camera 1 is a left eye camera in a first stereoscopic pair at a first location. Camera 3 is a right eye camera in the first stereoscopic pair at the first location. Camera 2 is a left eye camera in a second stereoscopic pair at a second location. Camera 4 is a right eye camera in the second stereoscopic pair at the second location.

Headmounted display 902 with displayed content includes: headmounted deplete left eye portion before the switch 904 and headmounted display right eye portion before the switch 906. Within headmounted display left eye portion before switch 904 is included image content including, at the center of area 904, player 1 at location X 603 captured from camera 1 with camera 1's perspective 908. Within headmounted display right eye portion before switch 906 is included image content including, at the center of area 906, player 1 at location X 603 captured from camera 3 with camera 3's perspective 910.

Headmounted display 902′ with displayed content includes: headmounted display left eye portion after the switch 904′ and headmounted display right eye portion after the switch 906′. Within headmounted display left eye portion after switch 904′ is included image content including, at the center of area 904′, player 1 at location X 603 captured from camera 2 with camera 2's perspective 958. Within headmounted display right eye portion after switch 906′ is included image content including, at the center of area 906′, player 1 at location X 603 captured from camera 4 with camera 4's perspective 960. The location X 603 has been maintained at the center of the display even though the cameras have been switched.

In this example, player 1 occupies a larger portion of the display screens in the after switch displayed image content as compared to the before switch displayed image content, e.g., because player 1 is closer to cameras 2 and 4, than player 1 is to cameras 1 and 3.

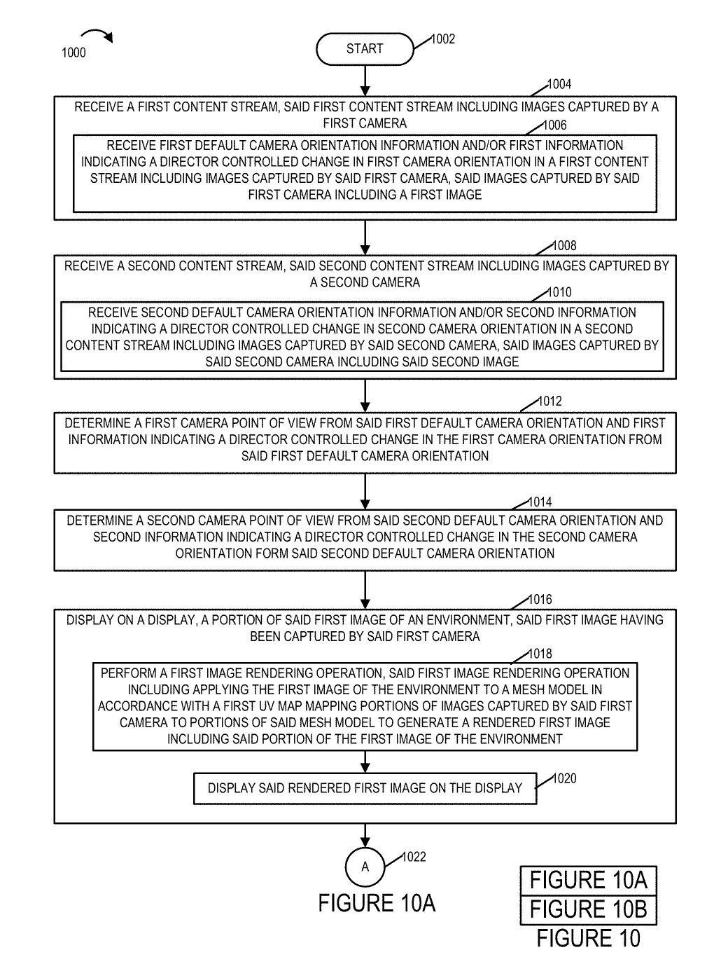

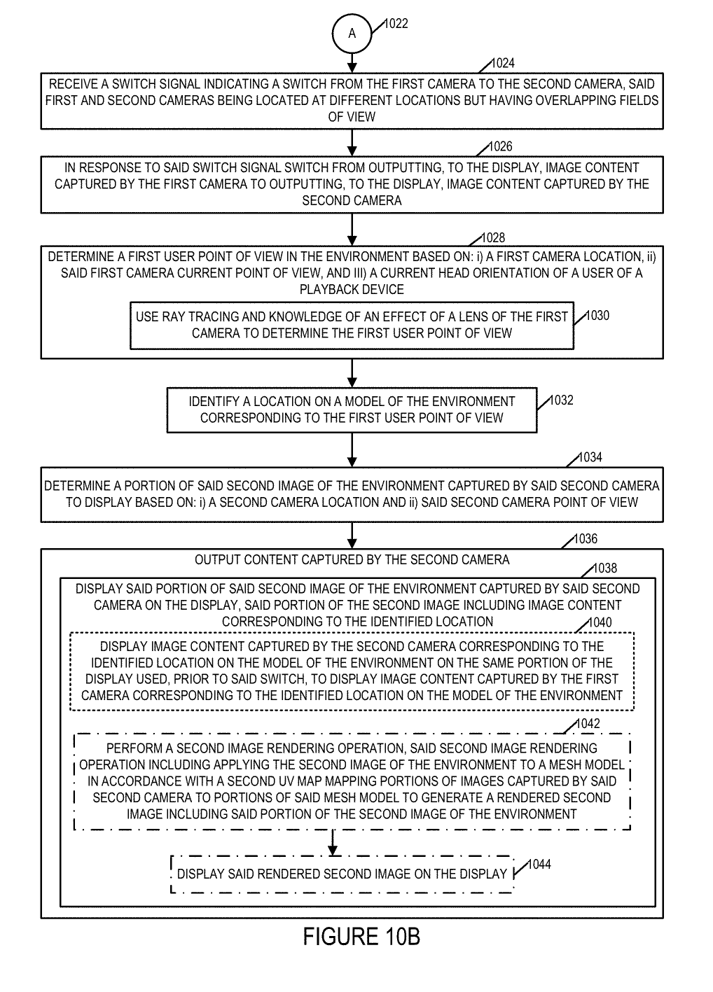

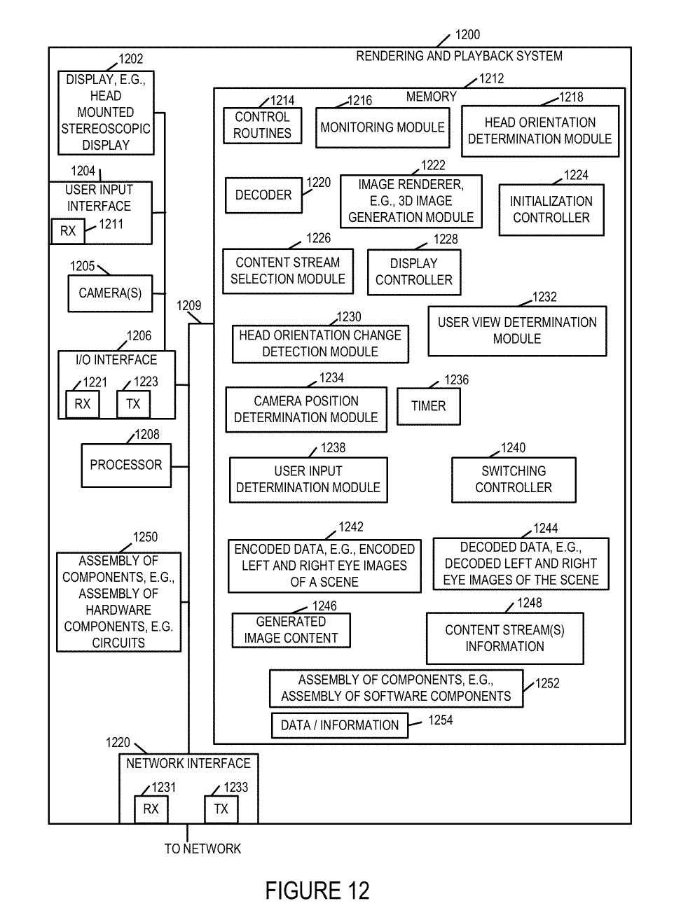

FIG. 10, comprising the combination of FIG. 10A and FIG. 10B, is a flowchart 1000 of an exemplary method of operating a rendering and playback system in accordance with an exemplary embodiment. In some embodiments, the system implementing the method of flowchart 1000 of FIG. 10 is, e.g., 3D rendering and playback system 122 of FIG. 1, rendering and playback system 200 of FIG. 2, rendering and playback system 300 of FIG. 3, or rendering an playback system 1200 of FIG. 12. Operation starts in step 1002 in which the rendering and playback system is powered on an initialized. Operation proceeds from step 1002 to step 1004. In step 1004 the rendering and playback system receives a first content stream, said first content stream including images captured by a first camera. Step 1004 includes step 1006, in which the rendering an playback system receives first default camera orientation information and/or first information indicating a director controlled change in first camera orientation in the first content stream including images captured by the first camera, said images captured by the first camera including a first image. Operation proceeds from step 1004 to step 1008.

In step 1008 the rendering and playback system receives a second content stream, said second content stream including images captured by a second camera. Step 1008 includes step 1010, in which the rendering an playback system receives second default camera orientation information and/or second information indicating a director controlled change in second camera orientation in the second content stream including images captured by the second camera, said images captured by the second camera including a second image. Operation proceeds from step 1008 to step 1012.

While steps 1004 and 1008 are shown at the top of FIG. 10 they may occur in parallel or at various locations in the flow diagram. For example in some embodiments a single content stream is streamed by the content delivery server 114 to an individual playback device at a given time. The content delivery server 114 in some embodiments determines which content stream to deliver to one or more playback device at a given time and then streams the content obtained by the selected camera. The streaming may and sometimes does occur in real time while an event, such as a sports game, is ongoing. A small delay corresponding to generation of the content streams may occur between image capture and streaming with a director or the content delivery server 114 selecting which camera feed will be streamed at a given time. A switch signal maybe and sometimes is sent to the playback device and received at the playback device when a decision to switch between content streams is made. The notification allows the playback device to determine a user's point of view and take steps to try and maintain the point of view to the extent possible despite the switch from one camera to another. Thus while receive steps 1004 and 1008 are shown at the start of FIG. 10, in some embodiments step 1004 is performed prior to the notification in step 1024 of the switch from the first camera to the second camera and step 1008 is performed immediately after or in parallel with step 1008 in which content captured by the second camera is received. The received content in either case will be image content of a real environment, e.g., images of a sports stadium, to which the environmental model used by the playback device during image rendering corresponds.

Returning to the discussion of the flow chart shown in FIG. 10, in step 1012 the rendering and playback system determines a first camera point of view from said first default camera orientation and first information indicating a director controlled change in the first camera orientation from said first default camera orientation. Operation proceeds from step 1012 to step 1014. In step 1014 the rendering and playback system determines a second camera point of view from said second default camera orientation and second information indicating a director controlled change in the second camera orientation from said second default camera orientation.

Operation proceeds from step 1014 to step 1016. In step 1016 the rendering and playback device displays on a display a portion of said first image of an environment, said first image having been captured by said first camera. Step 1016 includes step 1018 and step 1020. In step 1018 the rendering and playback device performs a first image rendering operation, said first image rendering operation including applying the first image of the environment to a mesh model in accordance with a first UV map mapping portions of images captured by said first cameras to portions of said mesh model to generate a rendered first image including said portion of the first image of the environment. Operation proceeds from step 1018 to step 1020. In step 1020, the rendering and playback device displays said rendered first image on the display. Operation proceeds from step 1016, via connecting node A 1022, to step 1024.

In step 1024 the rendering and playback device receives a signal indicating a switch from the first camera to the second camera, said first and second cameras being located at different locations but having overlapping fields of view. Operation proceeds from step 1024 to step 1026.

In step 1026 the rendering and playback device, in response to said switch signal, switches from outputting, to the display, image content captured by the first camera to outputting, to the display, image content captured by the second camera. Operation proceeds from step 1026 to step 1028.

In step 1028 the rendering and playback device determines a first user point of view in the environment based on: i) a first camera location, ii) said first camera current point of view, and iii) a current head orientation of a user of a playback device. In some embodiments, the first camera location is a first location in said environment, said first location being the location of the first camera in said environment. Step 1028 includes step 1030 in which the rendering and playback device uses ray tracing and knowledge of an effect of a lens of the first camera to determine the first user point of view. In some embodiments, the lens of the first camera is a fish eye lens and said ray tracing takes into considerations the distortions introduced by said fish eye lens into images captured by said first camera. In some such embodiments, the second camera also uses a fisheye lens. Operation proceeds from step 1028 to step 1032.

In step 1032 the rendering and playback device identifies a location on a model of the environment corresponding to the first user point of view. In some embodiments, the model of the environment is a mesh model and the identified location is a location of a node in said mesh model. In some embodiments, the model of the environment is a 3D model. Operation proceeds from step 1032 to step 1034.

In step 1034, the rendering and playback device determines a portion of the second image of the environment, e.g., including the identified location, captured by said second camera to display based on: i) a second camera location and ii) said second camera point of view. In some embodiments, the first camera location and the second camera location are locations in a sports stadium or concert venue. Operation proceeds from step 1034 to step 1036.

In step 1036 the rendering and playback device outputs content captured by the second camera. Step 1036 includes step 1038 in which the rendering and playback device displays said portion of said second image of the environment captured by the second camera on the display, said portion of the second image including image content corresponding to the identified location. In various embodiments, step 1038 includes step 1040 or steps 1042 and 1044.

In step 1040 the rendering and display device displays image content captured by the second camera corresponding to the identified location on the model of the environment on the same portion of the display used, prior to said switch, to display image content captured by the first camera corresponding to the identified location on the model of the environment. In some embodiments, said first camera is a first camera of a first stereoscopic camera pair including a left eye camera and a right eye camera used to capture left and right eye images, respectively; said second camera is a first camera of a second stereoscopic camera pair including a left eye camera and a right eye camera used to capture left and right eye images, respectively; and said same portion of the display is a portion located at the center of one of a left portion of the display used to display a left eye image and a right portion of the display used to display a right eye image.

In step 1042, the rendering and playback device performs a second image rendering operation, said second image rendering operation including applying the second image of the environment to a mesh model in accordance with a second UV map mapping portion of images captured by said second camera to portions of said mesh model to generate a rendered second image including said portion of the second image of the environment. Operation proceeds from step 1042 to step 1044 in which the rendering and playback device display said rendered second image on the display.

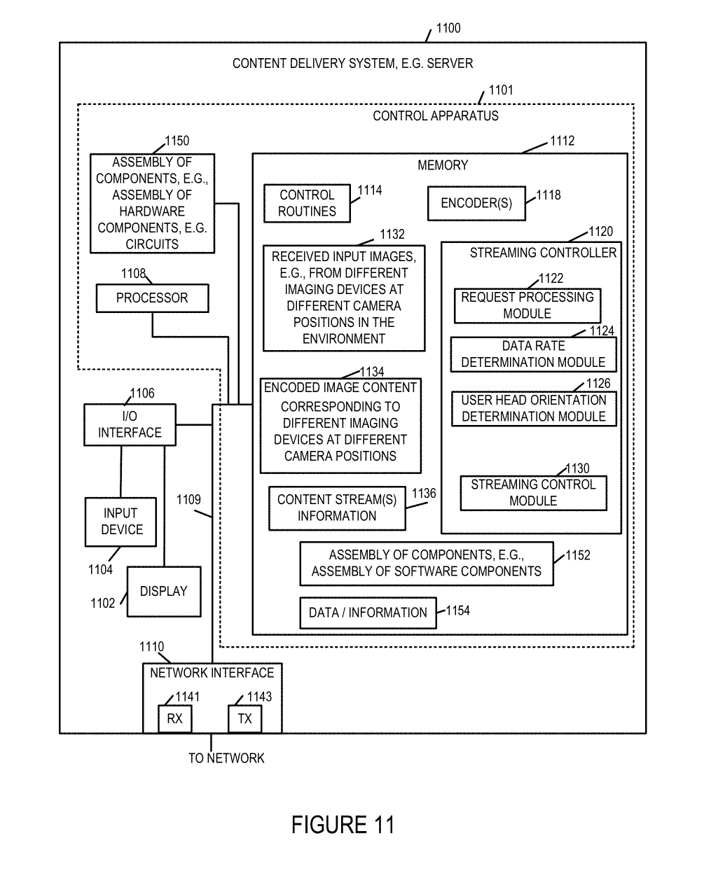

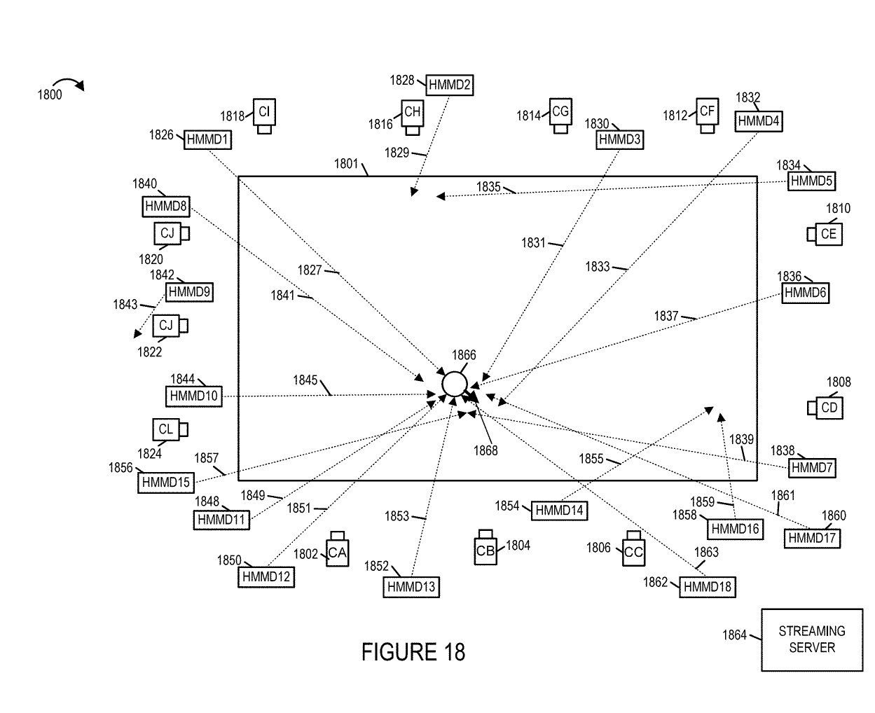

FIG. 11 illustrates an exemplary content delivery system that can be used to encode and stream content in accordance with the features of the invention. The system may be used to perform encoding, storage, and transmission and/or content output in accordance with the features of the invention. The content delivery system 1100 may be used as the system 104 of FIG. 1 or the server 1864 of FIG. 18. While the system shown in FIG. 11 is used for encoding, processing and streaming of content, it should be appreciated that the system 1100 may also include the ability to decode and display the received, processed and/or encoded image data, e.g., to an operator.

The system 1100 includes a display 1102, input device 1104, input/output (I/O) interface 1106, a processor 1108, network interface 1110, an assembly of components 1150, e.g., an assembly of hardware components, e.g., circuits, and a memory 1112. The various components of the system 1100 are coupled together via bus 1109 which allows for data to be communicated between the components of the system 1100. The system 1100 in some embodiments receives imaging content 1132 captured by the imaging devices at various different camera positions in the environment via the network interface 1110 and/or the I/O interface 1106. In some embodiments the system 1100 processes and encodes the received imaging data 1132 prior to delivering the content, e.g., over communications network 105, to customer rendering and playback systems such as systems 122, 124. Via the display 1102 the system 1100 can display the received, processed and/or encoded image data, e.g., to an operator. Via the input device 1104, which may be a keyboard, touch sensitive screen or another such input interface, an operator can provide input to the system 1100, e.g., to provide one or more input parameters and/or commands. Via the network interface 1110 (which includes a receiver 1141 and transmitter 1143) the system 1100 communicates (receives and/or transmits information) with external devices over the communications network 105. In some embodiments the system 1100 delivers encoded imaging content, acquired from one or more camera devices which captured the imaging content, to customer rendering and playback systems such as systems 122, 124, e.g., over communications network 105.

The memory 1112 includes various modules, e.g., routines, which when executed by the processor 1108 control the computer system 1100 to implement image, e.g., video, acquisition, encoding, storage, and transmission and/or output operations in accordance with the invention. The memory 1112 includes control routines 1114, encoder(s) 1118, a streaming controller 1120, received input images 1132, e.g., stereoscopic or normal video of a scene, encoded image data 1134, and content stream(s) information 1136. In some embodiments the modules are, implemented as software modules. In other embodiments the modules are implemented in hardware, e.g., as individual circuits with each module being implemented as a circuit for performing the function to which the module corresponds. In still other embodiments the modules are implemented using a combination of software and hardware.

The memory 1112 further includes an assembly of components 1150, e.g., an assembly of software components, and data/information 1154. The processor 1108, assembly of components 1150, and memory 1112 are part of control apparatus 1101.

The encoder(s) 1118 may, and in some embodiments do, include a plurality of encoders configured to encode received image content, e.g., a scene and/or one or more scene portions. In some embodiments encoder(s) include multiple encoders with each encoder being configured to encode a scene and/or partitioned scene portions to support a given bit rate stream. The scene may be a stereoscopic scene. Thus in some embodiments each scene portion can be encoded using multiple encoders to support multiple different bit rate streams for each scene. An output of the encoder(s) 1118 is the encoded image content 1134 which are stored in the memory for streaming to customer devices, e.g., rendering and playback devices. The encoded content can be streamed to one or multiple different devices via the network interface 1110.

The streaming controller 1120 is configured to control streaming of encoded content for delivering the encoded image content 1134 to one or more customer devices, e.g., over the communications network 105. The streaming controller 1120 includes a request processing module 1122, a data rate determination module 1124, a user head orientation determination module 1126, and a streaming control module 1130. The request processing module 1122 is configured to process a received request for imaging content from a customer rendering and playback system. The request for content is received in various embodiments via a receiver in the network interface 1110. In some embodiments the request for content includes information indicating the identity of requesting rendering and playback system. In some embodiments the request for content may include data rate supported by the customer playback device, a current head orientation of the user, e.g., orientation of the head mounted display. The request processing module 1122 processes the received request and provides retrieved information to other elements of the streaming controller 1120 to take further actions. While the request for content may include data rate information and current head position information, in various embodiments the data rate supported by the playback device can be determined from network tests and other network information exchange between the system 1100 and the playback and rendering systems. While in some embodiments some customer rendering and playback systems may request content streams based on determined head orientation of the user at the given time, e.g., to allow the user to view the environment from the perspective of a desired camera position in the environment, in many cases the customer rendering and playback systems may not specifically request a content stream but rather simply attach to a broadcast content stream among a plurality of content streams broadcast by the content delivery system 1100. In some embodiments the content delivery system 1100 broadcasts different content streams corresponding to different available camera positions in an environment in accordance with the invention. The content delivery system 1100 provides content stream information 1136 to the customer rendering and playback systems providing information regarding a plurality of content streams that may be available for receiving and use in playback and indicating information needed to tune to the broadcast content streams. The content stream information 1136 also indicates which content stream communicates and corresponds to which camera position in the environment to allow the customer rendering and playback systems to select and receive the appropriate content stream. The customer systems may also use the stream information 1136 to request a particular content stream corresponding to a user selected camera position at a given time in accordance with the invention.

The data rate determination module 1124 is configured to determine the available data rates that can be used to stream imaging content to customer devices, e.g., since multiple encoded scene portions are supported, the content delivery system 1100 can support streaming content at multiple data rates to the customer device. The data rate determination module 1124 is further configured to determine the data rate supported by a playback device requesting content from system 1100. In some embodiments the data rate determination module 1124 is configured to determine available data rate for delivery of image content based on network measurements.

The user head orientation determination module 1126 is configured to determine a current viewing angle and/or a current head orientation of the user, e.g., orientation of the head mounted display, from information received from the customer rendering and playback system. The streaming control module 1130 is configured to control streaming of image content at various supported data rates in some embodiments.

FIG. 12 illustrates an exemplary rendering and playback system 1200 that can be used to receive, decode and display the content streamed by the content streaming system of FIGS. 1 and 11. The exemplary rendering and playback system 1200 may be used as any of the rendering and playback systems shown in FIGS. 1-3. The rendering and playback system 1200 in some embodiments include and/or coupled to a 3D head mounted display. The system 1200 includes the ability to decode the received encoded image data and generate 3D image content for display to the customer. The rendering and playback system 1200 in some embodiments is located at a customer premise location such as a home or office but may be located at an image capture site as well. The rendering and playback system 1200 can perform signal reception, decoding, viewing position and/or content presentation control, display and/or other operations in accordance with the invention.

The exemplary rendering and playback system 1200 can receive, decode, store and display imaging content, e.g., in a simulated environment, to a user of the system 1200. The exemplary rendering and playback system 1200 may be used as the rendering and playback systems 122, 124, 200 and 300 shown in FIGS. 1-3. The system 1200 includes the ability to decode received encoded image data, e.g., left and right eye images and/or mono (single images) captured by imaging apparatus located at various different camera positions in an environment from where content is being captured and generate image content for display to a user in accordance with the features of the invention.

The rendering and playback system 1200 includes a display 1202, input interface 1204, one or more cameras 1205, input/output (I/O) interface 1206, a processor 1208, network interface 1210, an assembly of components 1250, e.g., an assembly of hardware components, e.g., circuits, and a memory 1212. The various components of the system 1200 are coupled together via bus 1209 which allows for data to be communicated between the components of the system 1200 and/or by other connections or through a wireless interface. The rendering and playback system 1200 includes the head mounted 3D display 1202 on which the image content is presented, e.g., with left and right eyes of a user being presented with different images in the case of stereoscopic content. By displaying different images to the left and right eyes on a single screen, e.g., on different portions of the single screen to different eyes, a single display can be used to display left and right eye images which will be perceived separately by the viewers left and right eyes. In some embodiments the playback and rendering system 1200 is used as the playback and rendering system 200 and a cell phone/Smartphone screen is used as the display 1202. In some other embodiments the playback and rendering system 1200 is used as the playback and rendering system 300. The head mounted display 1202 maybe implemented using the OCULUS RIFT™ VR (virtual reality) headset which may include the head mounted display 1202. Other head mounted displays may also be used. In a case where a cell phone, e.g., Smartphone, processor is used as the processor 1208 and the cell phone generates and displays images in a head mount assembly (such as head mount 102), the system 1200 may include as part of the head mount device the processor 1208, display 1202, camera(s) 1205 and memory 1212. The processor 1208, display 1202 and memory 1212 may all be part of the cell phone. In other embodiments of the system 1200, the processor 1208 may be part of a gaming system such as an XBOX, PS3, PS4 etc., with the display 1202 being mounted in a head mounting device and coupled to the gaming system. Whether the processor 1208 or memory 1212 are located in the device which is worn on the head or not is not critical and, as can be appreciated, while in some cases it may be convenient to collocate the processor in the headgear, from a power, heat and weight perspective it can be desirable to in at least some cases to have the processor 1208 and memory coupled to the head gear which includes the display. While various embodiments contemplate a head mounted display 1202, the methods and system can also be used with non-head mounted displays which can support 3D image.

The operator/user of the playback and rendering system 1200 may control one or more parameters, input information, commands etc., via the user input interface 1204 and/or select operations to be performed, e.g., select to display simulated environment including scene content. Via the user input interface 1204 a user provides input to the rendering and playback system 1200, e.g., input indicating a user selected switch from a first camera position to another camera position. The user input interface may include, for example, a keyboard, keypad, touchpad and/or touch sensitive screen. The user input interface 1204 includes a receiver 1211 via which the rendering and playback system 1200 receives the information/data provided by the user. The user may use the user input interface 1204 to make a selection of item and/or respond to a displayed prompt and/or other indication requiring user's input. For example user can provide input selecting a different camera position than a currently selected camera position from which the user is viewing the environment. The user input may be provided e.g., by a single tap, double tap or some other action on the input interface 1204.

The camera(s) 1205 includes one or more cameras which can be, and sometimes are, used to capture images, e.g., of persons, physical environment and/or objects in the physical environment where the system 1200 is located. In some embodiments where the system 1200 is used as the rendering and playback 200 the camera 1205 may be the camera device of the Smartphone being used in the system 200. In some embodiments where the system 1200 is used as the rendering and playback system 300 the camera 1205 may be the camera located on the rendering device 302 or on the head mounted display 304.

Via the I/O interface 1206, the system 1200 can be coupled to external devices to exchange signals and/or information with other devices. In some embodiments via the I/O interface 1206 the system 1200 can receive information and/or images captured by external cameras and output information and/or images to external devices. The I/O interface 1206 includes a receiver (RX) 1221 and a transmitter (TX) 1223 via which the receiving and transmitting operations are performed. In some embodiments via the interface 1206 the system 1200 is coupled to an external controller, e.g., such as the handheld controller 306. In embodiments where a handheld controller 306 is available, the handheld controller 306 may be coupled to the I/O interface 1206 and used to enter information and/or provide user input, e.g., selecting a camera position from which the user would like to experience the environment, to the system via the I/O interface 1206.

The processor 1208, e.g., a CPU, executes routines 1214 and uses the various modules to control the system 1200 to operate in accordance with the invention. The processor 1208 is responsible for controlling the overall general operation of the system 1200. In various embodiments the processor 1208 is configured to perform functions that have been discussed as being performed by the playback and rendering system 1200.

Via the network interface 1220 the system 1200 communicates and/or receives signals and/or information (e.g., including images and/or video content corresponding to a scene) to/from various external devices over a communications network, e.g., such as communications network 105. The network interface 1220 includes a receiver 1231 and a transmitter 1233 via which the receiving and transmitting operations are performed. In some embodiments the system receives one or more content streams via the network interface 1220 from the content delivery system 104. In some embodiments the system 1200 receives, via the receiver 1231 of interface 1220, one or more content streams communicating content captured by one or more camera devices located at different camera positions in an environment to use for playback, e.g., stream communicating content corresponding to a scene of an event, e.g., soccer game. The received content stream may be received as encoded data, e.g., encoded scene data 1242.

In some embodiments the memory 1212 includes various routines and/or modules which when executed by the processor 1208 control the rendering and playback system 1200 to perform operations in accordance with the invention. The memory 1212 includes control routines 1214, a monitoring module 1216, a head orientation and/or viewing angle determination module 1218, a decoder 1220, an image renderer 1222, an initialization controller 1224, a content stream selection module 1226, a display controller 1228, a head orientation change detection module 1230, a determination module 1232, a camera position determination module 1234, a timer 1236, user input determination module 1238, and a switching controller 1240. The memory 1212 further includes data/information including encoded data 1242, decoded data 1244 and generated image content 1246. Memory 1212 further includes assembly of components 1252, e.g., an assembly of software components, and data/information 1254.

The control routines 1214 include device control routines and communications routines to control the operation of the system 1200. The monitoring module 1216 is configured to monitor for user input, commands, instructions provided by the user via, e.g., the user input interface 1204 and/or I/O interface 1206. In some embodiments the monitoring module 1216 monitors for user control inputs for controlling the rendering and playback system 1200, e.g., control zooming to a displayed area, controlling volume and/or other features.

The head orientation and/or viewing angle determination module 1218 is configured to determine a current head orientation of the user, e.g., orientation of the head mounted display. The head orientation determination module 1218 may be implemented using one or a combination of sensors to detect user's head orientation at a given time. In some embodiments the determined head orientation and/or change in orientation from a reference orientation is used in determining which of a plurality of camera position the user is viewing at a given time.

The decoder 1220 is configured to decode encoded image content 1242, e.g., encoded content communicated in a content stream received from a content delivery system to produce decoded image data 1244. The decoded image data 1244 may include decoded images captured by imaging devices located at various camera positions in an environment where the images are captures. The image renderer 1222 uses decoded image data including content corresponding to a scene to generate content for displaying to a user on the display 1202. The generated imaging content 1246 which is displayed to a user is the output of the image renderer 1222. The image renderer 1222 may be implemented as a 3D image generation module to render 3D stereoscopic image content.

The initialization module 1224 is configured to set the detected current head orientation as a default/reference head orientation, e.g., 0 degree head rotation and head tilt angles, during the system operation initialization phase. The initialization module 1224 is further configured to initialize a current viewing position by setting the current viewing position to correspond to a first camera position, e.g., a default camera position (predetermined) or a last used camera position. During content display a current viewing position corresponds to a currently selected camera position from where the user will experience the content in the displayed simulated environment.

The content stream selection module 1226 is configured to select a content stream communicating content captured by an imaging device at the selected camera position, e.g., camera position selected by the initialization module 1224 during initialization and/or selected by the user. In various embodiments the content stream selection module 1226 uses the content stream information 1248 to decide which stream(s) to select for use in display. Depending on a camera position selected at a given time the content stream selection module 1226 selects a corresponding content stream accordingly. The display controller 1228 is configured to control displaying of a simulated environment including content corresponding to a user selected camera position in the environment to the user on the display device 1202. The display controller 1228 is configured to control presentation, e.g., display, of content corresponding to the selected camera position in the environment, e.g., on the head mounted display 1202. Thus during initialization the display controller 1228 controls presentation of content corresponding to a first camera position, e.g., default or last used camera position, e.g., with the user being presented content from the perspective of the first camera position which has been chosen as the default camera position during initialization. At another time the display controller 1228 may control presentation of content corresponding to another user selected camera position in the environment.

The head orientation change detection module 1230 is configured to monitor the user's current head orientation to detect changes in the head orientation, e.g., due to rotation of head, tilting of the head or both rotation and tilting, from an initial/current head orientation. In some embodiments the head orientation change detection module 1230 monitors for changes in the head orientation following the initial detection of user's head orientation and setting of the default/reference head orientation. The head orientation change detection module 1230 is configured to detect changes in the head orientation relative to a currently set head orientation at a given time, e.g., default/reference head orientation initially detected by the head orientation determination module 1218. Thus if the user's head orientation changes from the initially detected head orientation, e.g., due to head rotation, tilt or both, the head orientation change detection module 1230 receives an input from the head orientation determination module 1218 indicating a current head orientation and compares it against the currently set/previously detected head orientation of the user stored in memory 1212 to determine if there has been any changes in the head orientation. In some embodiments the head orientation change detection module 1230 is further configured to determine the head angle of rotation and/or head tilt angle relative to the default head orientation, e.g., how much has the user rotated and/or tilted his/her head from the 0° position corresponding to the default/reference head orientation or an angle corresponding to the previously detected head orientation. In various embodiments such head angle of rotation and/or head tilt angle information is used to determine if the user has been viewing another camera position in the environment.

The determination module 1232 is configured to determine if the user is viewing another camera position in the environment at a given time. In some embodiments the determination module 1232 is configured to determine if the user is viewing another camera position in the environment from i) head angle of rotation, ii) head tilt angle or iii) both the user head angle of rotation and user head tilt angle. In various embodiments the determination module 1232 receives the information indicating the changes in head orientation, e.g., head angle of rotation and/or head tilt angle from the head orientation change detection module 1230 and uses this information to make a determination whether the user is viewing another camera position in the environment. In some embodiments the determination module 1232 includes the head orientation change detection module 1230. In various embodiments when it is determined that the user has been viewing the another camera position the monitoring module 1216 monitors for monitors, while the user of the system 1200 is viewing the another camera position in the environment, to detect user input indicating a user selected switch to the another camera position. In some embodiments the monitoring module 1216 monitors for user input on a control input interface (e.g., such as the user interface 1204) while the user is viewing the another camera position.

The camera position determination module 1234 is configured to determine which of a plurality of alternative camera positions the user is viewing based on at least one of the user head angle of rotation or the head tilt angle. The timer 1236 is configured to determine if the user has been viewing the another camera position for a predetermined time. In some embodiments the timer 1234 monitors the time elapsed since the user has been determined to be viewing the other camera position and detect if the elapsed time equals or exceeds the predetermined time. In various embodiments when it is determined that the user has not been viewing the another camera position or was viewing the another camera position for less than the predetermined time, the display controller 1228 is configured to control the system to continue displaying, e.g., on the display 1202, content corresponding to the first camera position. In various embodiments when it is determined that the user has been viewing the another camera position for the predetermined time, the display controller 1228 is configured to control the system 1200 to present, e.g., display along with the content being presented, the user an indication that the user can switch to viewing the environment from a perspective of the another camera position. In some embodiments the display controller 1228 is configured, as part of presenting the user an indication that the user can switch to viewing the environment from a perspective of the another camera position, to provide a visual indication corresponding to the another camera position indicating that a switch to viewing the environment from the perspective of the another camera position is possible. In some embodiments the visual indication is one of at least a change in color or shading at said another camera position. In some embodiments the visual indication includes text in the area of said another camera position putting the user on notice of the potential to switch to viewing from the perspective of said another camera position.

The user input determination and processing module 1238 is configured to determine if the user input indicating a user selected switch to the another camera position has been detected, e.g., on the user input interface 1204 or other interface, within a predetermined time of the start of presenting the indication to the user, e.g., visual indication. The user input determination and processing module 1238, upon determining that a user input has been detected at a user interface, processes the user input information and/or commands/instructions and take action accordingly and/or provide the received input to another system element for further processing, action or storage in the memory 1212. In some embodiments when it is determined that the user input indicating a user selected switch to the another camera position has not been detected within the predetermined time from the start of presenting the indication the user input determination and processing module 1238 provides an instruction to the display controller 1228 to eliminate, e.g., exclude from being displayed, the indication that the user can switch to the another camera position. Accordingly the display controller 1228 controls the system 1200 to eliminate the indication indicating that the user can switch to the another camera position.

In various embodiments when it is determined that the user input indicating a user selected switch to the another camera position has been detected within the predetermined time the user input determination and processing module 1238 provides an instruction to the stream selection module 1226 to select a content stream corresponding to the another camera position. Thus when it is determined that the user input indicating a user selected switch to the another camera position has been detected within the predetermined time the stream selection module 1226 is configured to select a content stream communicating content captured by an imaging device located at the another, e.g., second, camera position in the environment.

The switching controller 1240 is configured to control the system 1200 to switch from displaying to the user content corresponding to the first camera position in the environment to displaying content corresponding to the another camera position in the environment when it is determined that the user input indicating a user selected switch to the another camera position has been detected within the predetermined time. In some such embodiments switching controller 1240 is configured to control the system to switch from receiving and displaying a first broadcast content stream corresponding to an output of a first imaging device, e.g., a first stereoscopic camera pair, located at the first camera position to receiving and displaying a second broadcast content stream corresponding to an output of a second imaging device, e.g., a second stereoscopic camera pair, located at said another camera position.

The content stream information 1248 includes information regarding a plurality of content streams that may be available for receiving and use in playback. In some embodiments the stream information 1248 is provided by the content provider's content delivery system 1100 (e.g., stream information 1136). In some embodiments the different available content streams correspond to different imaging devices located at different camera positions in the environment. In some embodiments the stream information 1248 includes, for a plurality of available content streams, one of a multicast address of a multicast group which can be joined to receive a given content stream corresponding to a given camera position, information which can be used to request access to a switched digital video channel used to provide a given content stream corresponding to a given camera position, or channel tuning information which can be used to control a tuner of the playback system 1200 to tune to a broadcast channel on which a given content stream corresponding to a given camera position is broadcast.

In some embodiments the modules and/or elements shown in the memory 1212 are implemented as software modules. In other embodiments the elements, while shown to be included in the memory 1212, are implemented in hardware, e.g., as individual circuits with each element being implemented as a circuit for performing the function corresponding to the element. In still other embodiments the modules and/or elements are implemented using a combination of software and hardware.

While shown in FIG. 12 example to be included in the memory 1212, the elements shown included in the system 1200 can, and in some embodiments are, implemented fully in hardware within the processor 1208, e.g., as individual circuits. In other embodiments some of the elements are implemented, e.g., as circuits, within the processor 1208 with other elements being implemented, e.g., as circuits, external to and coupled to the processor 1208. As should be appreciated the level of integration of modules on the processor and/or with some modules being external to the processor may be one of design choice. Alternatively, rather than being implemented as circuits, all or some of the elements may be implemented in software and stored in the memory 1212 of the system 1200, with the software modules controlling operation of the system 1200 to implement the functions corresponding to the modules when the modules are executed by a processor, e.g., processor 1208. In still other embodiments, various elements are implemented as a combination of hardware and software, e.g., with a circuit external to the processor 1108 providing input to the processor 1208 which then under software control operates to perform a portion of a module's function.

While shown in the FIG. 12 embodiment as a single processor, e.g., computer, it should be appreciated that the processor 1208 may be implemented as one or more processors, e.g., computers. When one or more elements in the memory 1212 are implemented as software modules, the modules include code, which when executed by the processor 1208, configure the processor 1208 to implement the function corresponding to the module. In embodiments where the various modules shown in FIG. 12 are stored in the memory 1212, the memory 1212 is a computer program product comprising a computer readable medium comprising code, e.g., individual code for each module, for causing at least one computer, e.g., processor 1208, to implement the functions to which the modules correspond.

Completely hardware based or completely software based modules may be used. However, it should be appreciated that any combination of software and hardware, e.g., circuit implemented modules may be used to implement the functions. As should be appreciated, the modules illustrated in FIGS. 11 and 12 control and/or configure the systems 1100 and 1200 or elements therein respectively such as the processor 1108 and 1208 to perform the functions of corresponding steps of the methods of the present invention, e.g., such as those illustrated and/or described in the flowchart 1000.

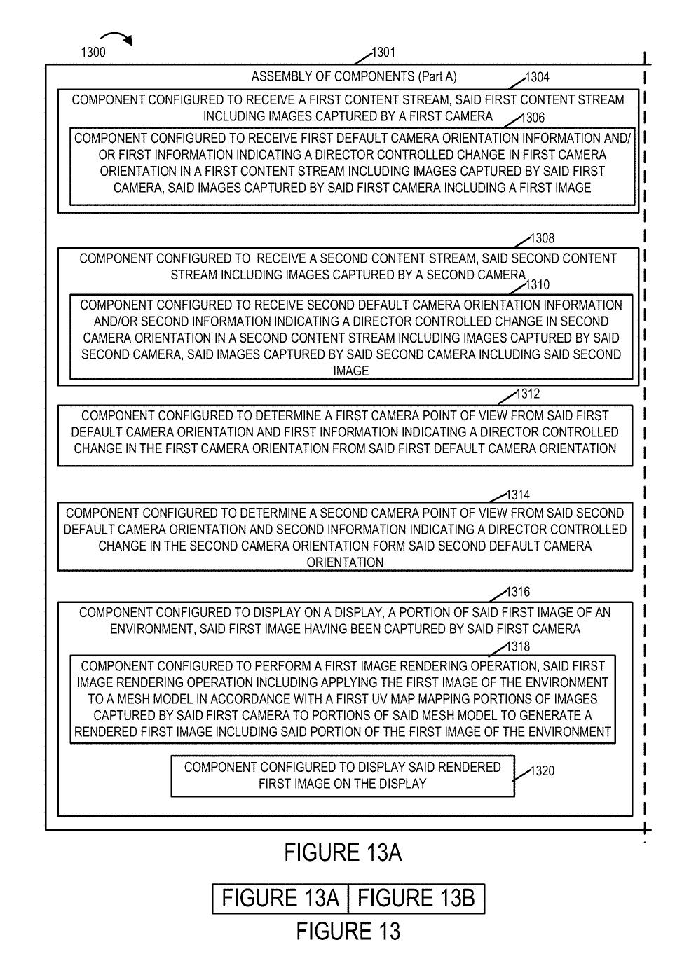

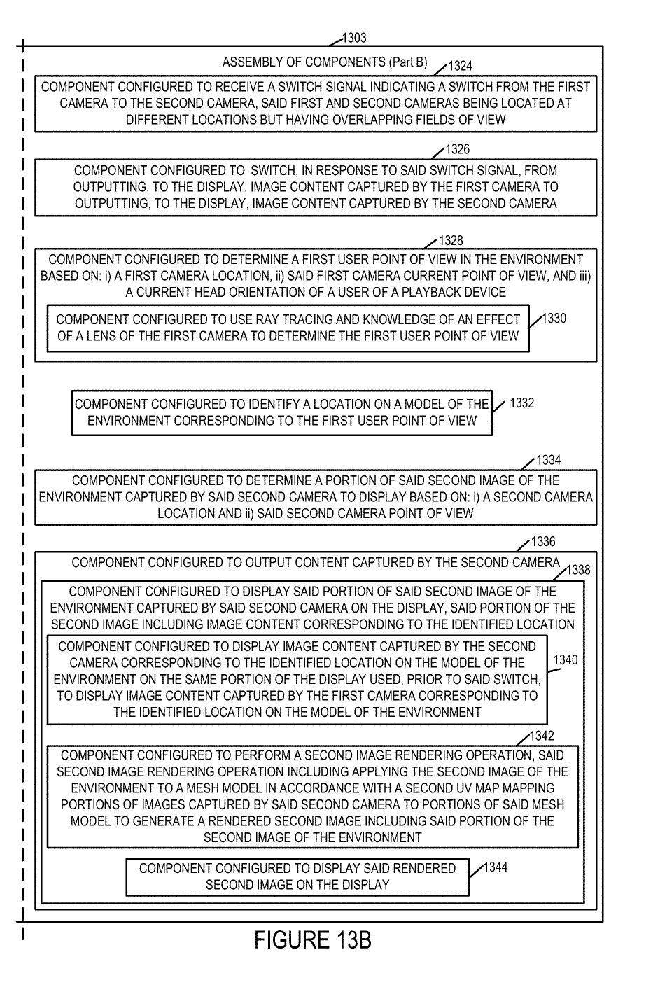

FIG. 13, comprising the combination of FIG. 13A and FIG. 13B, is a drawing of an assembly of components 1300, comprising the combination of Part 1301 and Part B 1303, in accordance with an exemplary embodiment. Assembly of components 1300 may be included in an exemplary rendering and playback system, e.g., a headmounted rendering and playback device, in accordance with an exemplary embodiment. In some embodiments, the exemplary rendering and playback system includes a rendering device coupled to a headmounted playback device and the some of the components in assembly of components 1300 are included in the rendering device and some of the components in assembly of components 1300 are included in the headmounted playback device. In some embodiments, the system including assembly of components 1300 is, e.g., 3D rendering and playback system 122 of FIG. 1, rendering and playback system 200 of FIG. 2, rendering and playback system 300 of FIG. 3, or rendering an playback system 1200 of FIG. 12.

In one embodiment, exemplary assembly of components 1300 is assembly of components 1250 in system 1200. In one embodiment, exemplary assembly of components 1300 is assembly of components 1252 in memory 1212 of system 1200. In one embodiment, assembly of components 1300 is included in processor 1208. Exemplary assembly of components 1300 is included in an exemplary rendering and playback system, e.g., any of the exemplary rendering and playback systems shown and/or described in the Figures and/or corresponding text.

Assembly of components 1300 may be included in an exemplary rendering and playback system 1200. The components in the assembly of components 1300 can, and in some embodiments are, implemented fully in hardware within a processor, e.g., processor 1208, e.g., as individual circuits. The components in the assembly of components 1300 can, and in some embodiments are, implemented fully in hardware within the assembly of hardware components 1250, e.g., as individual circuits corresponding to the different components. In other embodiments some of the components are implemented, e.g., as circuits, within processor 1208 with other components being implemented, e.g., as circuits within assembly of components 1250, external to and coupled to the processor 1208. As should be appreciated the level of integration of components on the processor and/or with some components being external to the processor may be one of design choice. Alternatively, rather than being implemented as circuits, all or some of the components may be implemented in software and stored in the memory 1212 of the system 1200, with the components controlling operation of system 1200 to implement the functions corresponding to the components when the components are executed by a processor e.g., processor 1208. In some such embodiments, the assembly of components 1300 is included in the memory 1212 as assembly of software components 1252. In still other embodiments, various components in assembly of components 1300 are implemented as a combination of hardware and software, e.g., with another circuit external to the processor providing input to the processor which then under software control operates to perform a portion of a component's function.

When implemented in software the components include code, which when executed by a processor, e.g., processor 1208, configure the processor to implement the function corresponding to the component. In embodiments where the assembly of components 1300 is stored in the memory 1212, the memory 1212 is a computer program product comprising a computer readable medium comprising code, e.g., individual code for each component, for causing at least one computer, e.g., processor 1208, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 13 control and/or configure the system 1200 or elements therein such as the processor 1208, to perform the functions of corresponding steps illustrated and/or described in the method of one or more of the flowchart 1000 of FIG. 10 and/or described with respect to any of the Figures. Thus the assembly of components 1300 includes various components that perform functions of corresponding one or more described and/or illustrated steps of an exemplary method, e.g., one or more steps of the method of FIG. 10.

Assembly of components 1300 includes a component 1304 configured to receive a first content stream including images captured by a first camera and a component 1308 configured to receive a second content stream, said second content stream including images captured by a second camera. Component 1304 includes a component 1306 configured to receive first default camera orientation information and/or first information indicating a director controlled change in first camera orientation in a first content stream including images captured by said first camera, said images captured by said first camera including a first image. Component 1308 includes a component 1310 configured to receive second default camera orientation information and/or second information indicating a director controlled change in second camera orientation in a second content stream including images captured by said second camera, said images captured by said second camera including a second image.

Assembly of components 1300 further includes a component 1312 configured to determine a first camera point of view from said first default camera orientation and first information indicating a director controlled change in the first camera orientation from said first default camera orientation, a component 1314 configured to determine a second camera point of view from said second default camera orientation and second information indicating a director controlled change in the second camera orientation from said second default camera orientation, an a component 1316 configured to display on a display a portion of said first image of an environment, said first image having been captured by said first camera. Component 1316 includes a component 1318 configured to perform a first image rendering operating including applying the first image of the environment to a mesh model in accordance with a first UV map mapping portions of the images captured by said first camera to portions of said mesh model to generate a rendered first image including said portion of the first image of the environment, and a component 1320 configured to display said rendered first image on the display.

Assembly of components 1300 further includes a component 1324 configured to receive a switch signal indicating a switch from the first camera to the second camera, said first and second cameras being located at different location but having overlapping fields of view, a component 1326 configured to switch, in response to said switch signal, from outputting, to the display, image content captured by the first camera to outputting, to the display, image content captured by the second camera, and a component 1328 configured to determine a first user point of view in the environment based on: i) a first camera location, ii) said first camera current point of view, and iii) a current head orientation of a user of a playback device. Component 1328 includes a component 1330 configured to use ray tracing and knowledge of an effect of a lens of the first camera to determine the first user point of view.

Assembly of components 1300 further includes a component 1332 configured to identify a location on a model of the environment corresponding to the first user point of view, a component 1334 configured to determine a portion of said second image of the environment captured by said second camera to display, e.g., said portion including the identified location, based on: i) a second camera location and ii) second camera point of view, and a component 1336 configured to output content captured by the second camera. Component 1336 includes a component 1338 configured to display said portion of said second image captured by said second camera on the display, said portion of the second image including image content corresponding to the identified location. Component 1228 includes a component 1340 configured to display image content captured by the second camera corresponding to the identified location on the model of the environment corresponding to the identified location on the mode of the environment on the same portion of the display used, prior to said switch, to display image content captured by the first camera corresponding to the identified location on the model of the environment, a component 1342 configured to perform a second image rendering operation, said second image rendering operation including applying the second image of the environment to a mesh model in accordance with a second UV map mapping portions of images captured by said second camera to portions of said mesh model to generate a rendered second image including said portion of the second image of the environment, and a component 1344 configured to display said rendered second image on the display.

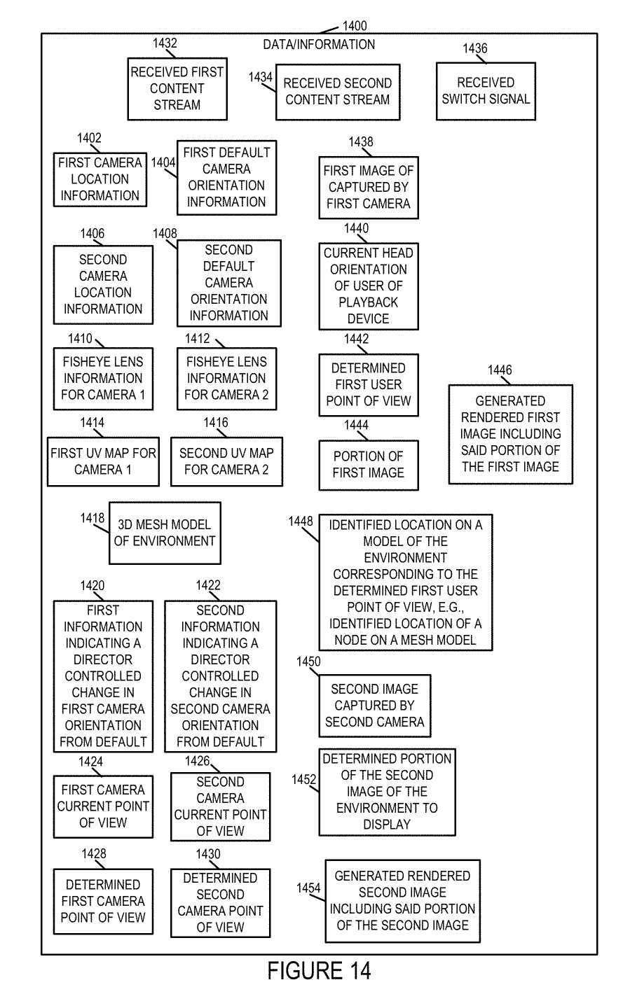

FIG. 14 is a drawing of exemplary data/information 1400 which may be included in an exemplary rendering and playback system, e.g., a headmounted rendering and playback device, in accordance with an exemplary embodiment. In some embodiments, the system including data/information 1400 is, e.g., 3D rendering and playback system 122 of FIG. 1, rendering and playback system 200 of FIG. 2, rendering and playback system 300 of FIG. 3, or rendering an playback system 1200 of FIG. 12. Data/information 1400 is, e.g., data/information 1254 of memory 1212 of rendering and playback system 1200 of FIG. 12.

Data/information 1400 includes first camera location information 1402, first camera default orientation information 1404, second camera location information 1406, second camera default orientation information 1408, first eye lens information for camera 1 1410, fisheye lens information for camera 2 1412, a first UV map for camera 1, a second UV map for camera 2 1416, a 3D mesh mode of the environment 1418, first information indicating a director controlled change in first camera orientation from the first camera default orientation 1420, second information indicating a director controlled change in second camera orientation from the second camera default orientation 1422, a first camera current point of view 1424, a second camera current point of view 1426, a determined first camera point of view 1428, a determined second camera point of view 1430.

Data/information 1400 further includes a received first content stream 1432, a received second content stream 1434, a received switch signal 1436, a first image captured by the first camera 1438, a current head orientation of the user of the playback devices 1440, a determined first user point of view 1442, a portion of the first image 144, a generated rendered first image including said portion of the first image 1446, an identified location on a model of the environment corresponding to the determined first user point of view 1448, e.g., an identified location of a node on the mesh model, a second image captured by the second camera 1450, a determined portion of the second image of the environment to display 1452, e.g., including the identified location, and a generated rendered second image including said portion of the second image 1454.

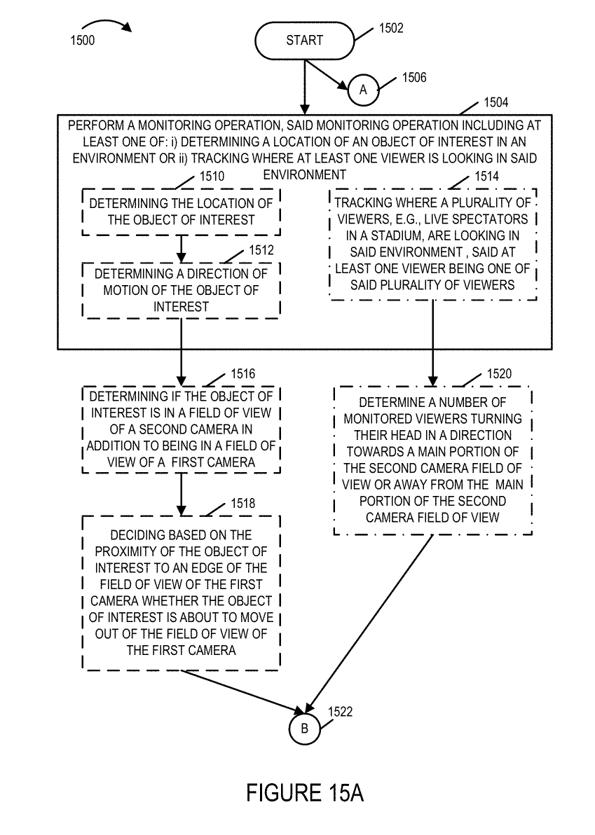

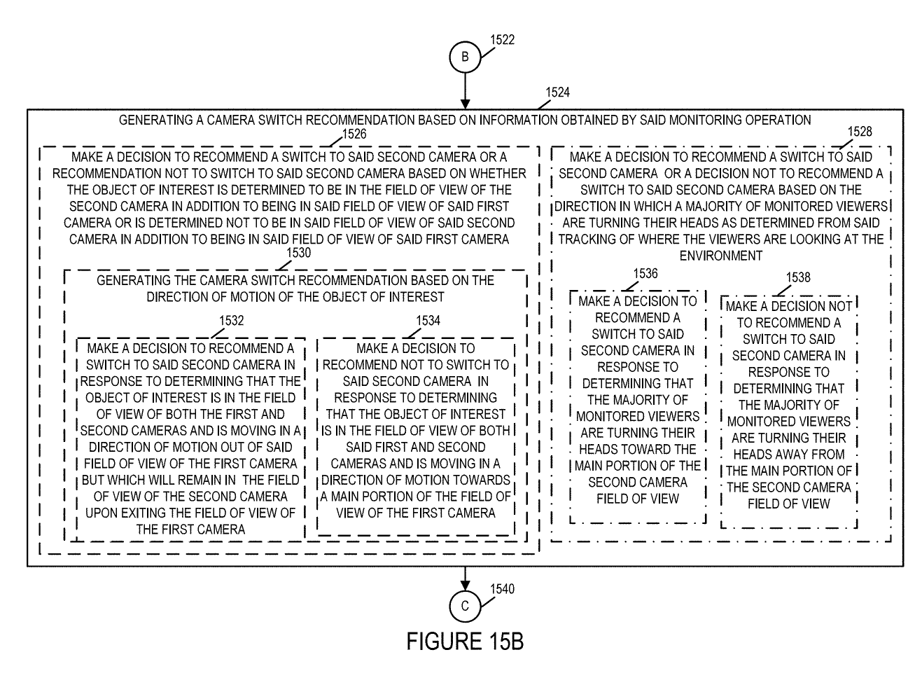

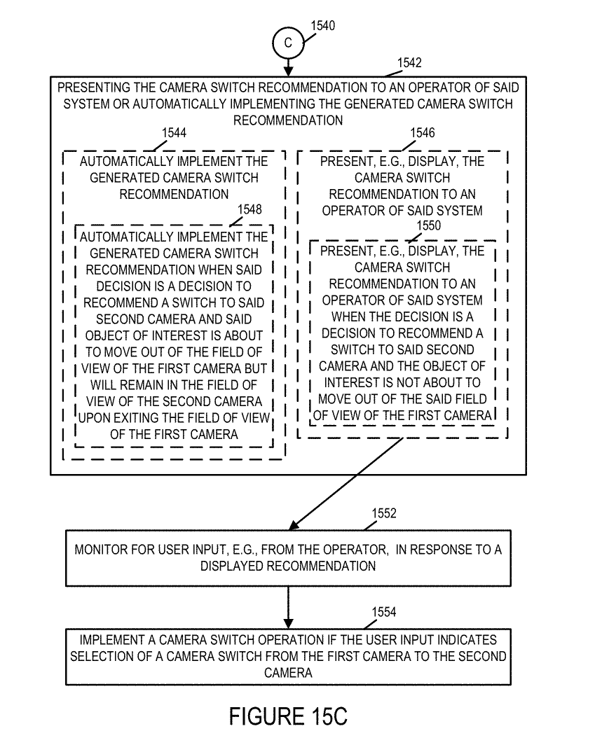

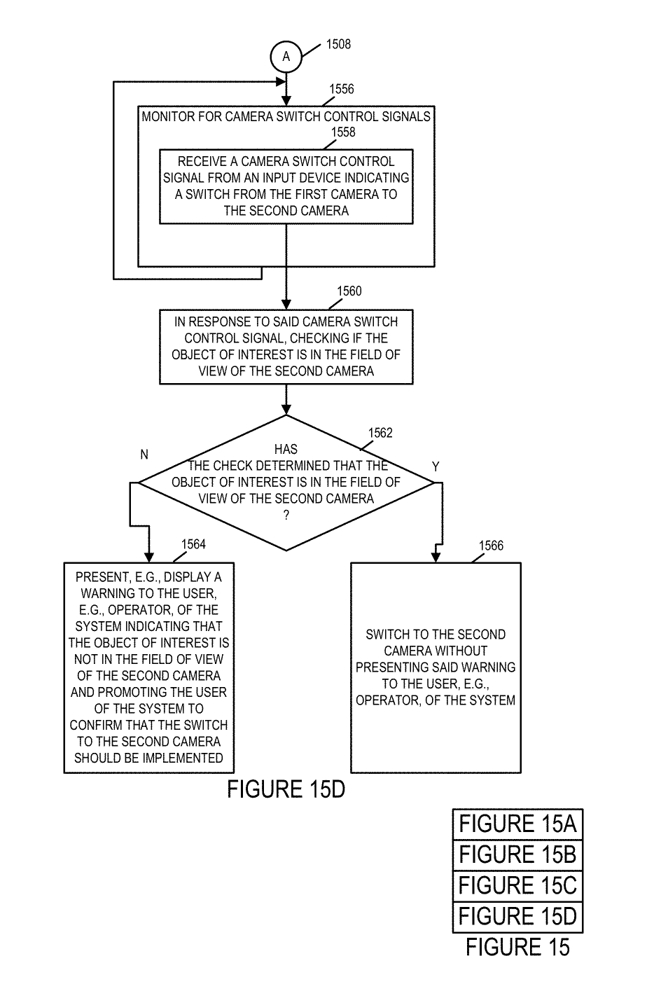

FIG. 15, comprising the combination of FIG. 15A and FIG. 15B, is a flowchart 1500 of an exemplary method of operating a system in accordance with an exemplary embodiment. In some embodiments, the system implement the method of flowchart 1500 is content delivery system 104 of FIG. 1 or content delivery system 1100 of FIG. 11. Operation starts in step 1502 in which the system is powered on and initialized and proceeds to step 1504 and, via connecting node A 1508, to step 1556.

In step 1504 a monitoring operation, e.g., monitor where an object of interest is or where viewers in the environment are looking, is performed, said monitoring operation including at least one of: i) determining a location of an object of interest in an environment or ii) tracking where at least one viewer, e.g., a spectator in the stadium, is looking in said environment, e.g., in a stadium or theater. The monitoring of one or more spectators can be performed while the event is ongoing and used in making decisions as to which camera should be selected as a content source at a given time. Given that there is small delay in encoding and streaming content there is enough time to use the real time information obtained from monitoring one or more spectator to facilitate which camera should be used as the source of streamed content provided to playback device in real time, e.g., while a sports game is still ongoing.

In some embodiments, e.g., at least embodiments in which said monitoring operation includes determining a location of an object of interest, step 1504 includes steps 1510 and 1510. In some embodiments, e.g., at least embodiments in which said monitoring operation includes tracking where at least one viewer, in the real environment where images are captured, is looking, step 1504 includes steps 1514.

In step 1510 the location of an object of interest is determined. Operation proceeds from step 1510 to step 1512. In step 1512 a direction of motion of the object of interest is determined. Operation proceeds from step 1512 to step 1516.

In step 1514, tracking where a plurality of views, e.g., live spectators in a stadium, are looking in said environment is performed, said at least one viewer being one of said plurality of viewers. Operation proceeds from step 1514 to step 1520.

Returning to step 1516, in step 1516 it is determined if the object of interest is in a field of view of a second camera in addition to being in a field of view of a first camera. Operation proceeds from step 1516 to step 1518. In step 1518 it is decided, based on the proximity of the object of interest to an edge of the field of view of the first camera whether the object of interest is about to move out of the field of view of the first camera. Operation proceeds, via connecting node B 1552, to step 1524.

Returning to step 1520, in step 1520 the number of monitoring viewers turning their head in a direction towards a main portion of the second camera field of view or away from the main portion of the second camera field of view is determined. Operation proceeds from step 1520, via connecting node B 1522, to step 1524.

In step 1524, a camera switch recommendation is generated based on information obtained by the monitoring operation. In some embodiments, the camera switch recommendation is generated for a streaming system server operator who controls streaming of content to end users, e.g., end users watching a sports game. In some embodiments, the information obtained by the monitoring operation is object of interest location and/or direction of movement information. In some embodiments, step 1524 includes step 1526. In some embodiments, step 1524 includes step 1528.

In step 1526, a decision is made to recommend a switch to said second camera or not to recommend a switch to said second camera based on whether the object of interest is determined to be in the field of view of said second camera in addition to being in said field of view of the first camera or is determined not to be in said field of view of the second camera in addition to being in said field of view of said first camera. In some embodiments, step 1526 includes step 1530 in which the camera switch recommendation is generated based on the direction of motion of the object of interest. Step 1530 includes step 1532 and step 1534. In step 1532 a decision is made to recommend a switch to said second camera in response to determining that the object of interest is in the field of view of both the first and second cameras and is moving in a direction of motion out of said field of view of the first camera but which will remain in the field of view of the second camera upon exiting the field of view of the first camera. In step 1534 a decision is made to recommend not to switch to said second camera in response to determining that the object of interest is in the field of view of both the first and second cameras and is moving in a direction of motion toward a main portion of the filed of view of the first camera.

Returning to step 1528, in step 1528 a decision is made to recommend a switch to said second camera or to not recommend a switch to said second camera based on the direction in which a majority of monitored viewers are turning their heads as determined from said tracking of where the viewers are looking at in the environment. Step 1528 includes steps 1536 and 1538. In step 1536 a decision is made to recommend a switch to said second camera in response to determining that the majority of monitored viewers are turning their heads toward the main portion of the second camera field of view. In step 1538 a decision is made not to recommend a switch to said second camera in response to determining that the majority of monitored viewers are turning their heads away from the main portion of the second camera field of view.

Operation proceeds from step 1524, via connecting node C 1540, to step 1542. In step 1542, the camera switch recommendation is presented to an operator of said system or the generated camera switch operation is automatically implemented. In various embodiments, step 1542 includes one or both of step 1544 and 1546. In step 1544 the generated camera switch recommendation is automatically implemented. Step 1544 includes step 1548 in which the generated camera switch recommendation is automatically implemented when said decision is a decision to switch to recommend a switch to said second camera and said object of interest is about to move out of the filed of view of the first camera but will remain in a field of view of the second camera upon exiting the field of view of the first camera.

Returning to step 1446, in step 1546, the camera switch recommendation is presented, e.g., displayed, to and operator of the system. Step 1546 includes step 1550 in which the camera switch recommendation is presented, e.g., displayed on control system display, to an operator of the system when the decision is a decision to recommend a switch to said second camera and the object of interest is not about to move out of the field of view of the first camera. Operation proceeds from step 1546 to step 1552.

In step 1552 monitoring for user input, e.g., from the operator of the system, is performed in response to the displayed recommendation. Operation proceeds from step 1152 to step 1554. In step 1554, a camera switch operation is implemented if the user input indicates selection of a camera switch from the first camera to the second camera.

Returning to step 1556, in step 1556, which is performed on an ongoing basis, monitoring for camera switch control signals is performed. Step 1556 includes step 1558 in which a camera switch control signal is received from An input device indicating a switch from the first camera to the second camera. Operation proceeds from step 1558 to step 1560. In step 1560, in response to said camera switch control signal, a check is performed to determine if the object of interest is in the field of view of the second camera. Operation proceeds from step 1560 to step 1562.

In step 1562, if the check determines that the object of interest is in the field of view of the second camera, then operation proceeds from step 1562 to step 1566; otherwise, operation proceeds from step 1562 to step 1564.

In step 1564, a warning to the user, e.g., operator, of the system, is presented, e.g., displayed, indicating that the object of interest is not in the filed of view of the second camera and promoting the user of the system to confirm that the switch to the second camera should be implemented. In step 1566, the switch to the second camera is performed without presenting said warning to the user, e.g., operator, of the system.

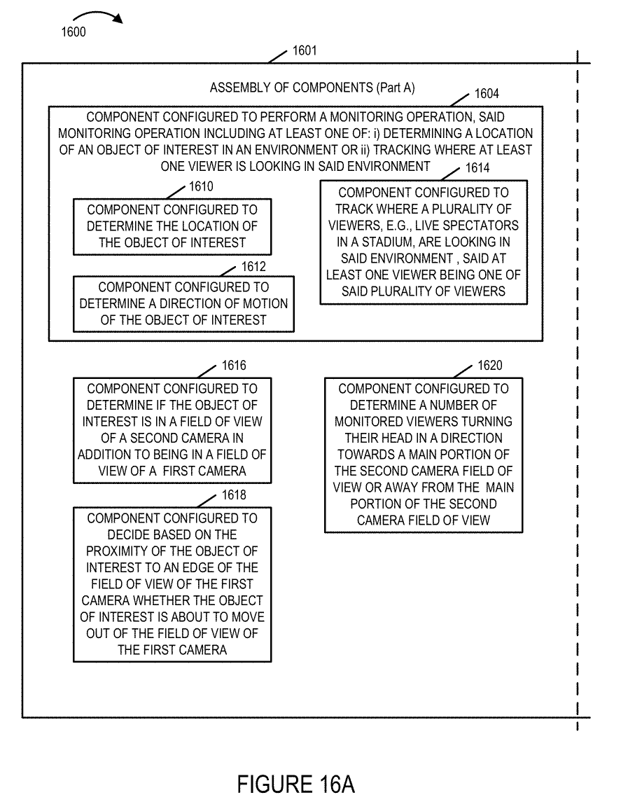

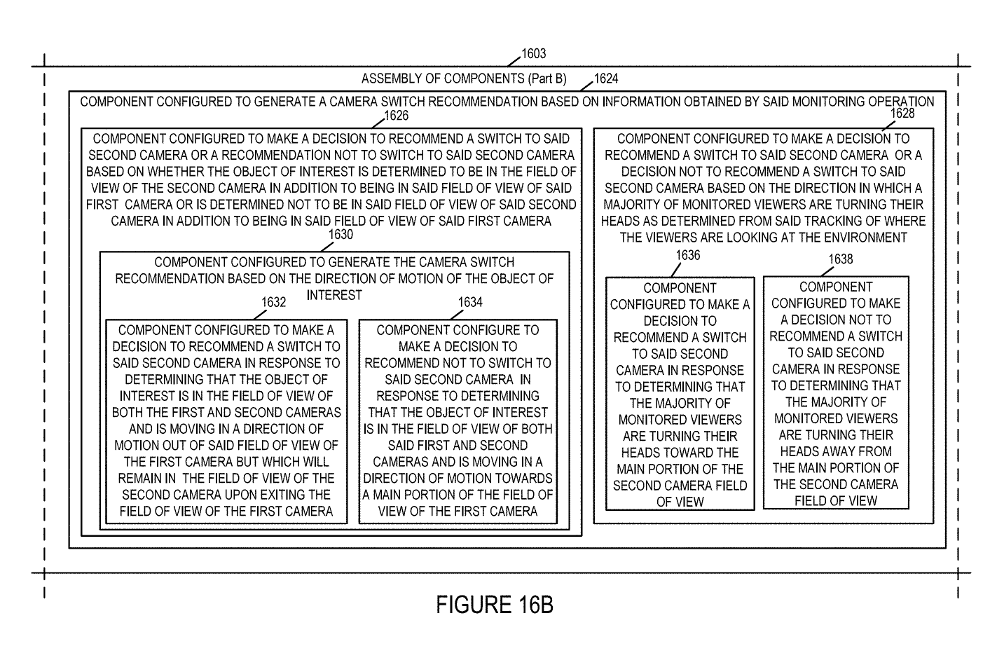

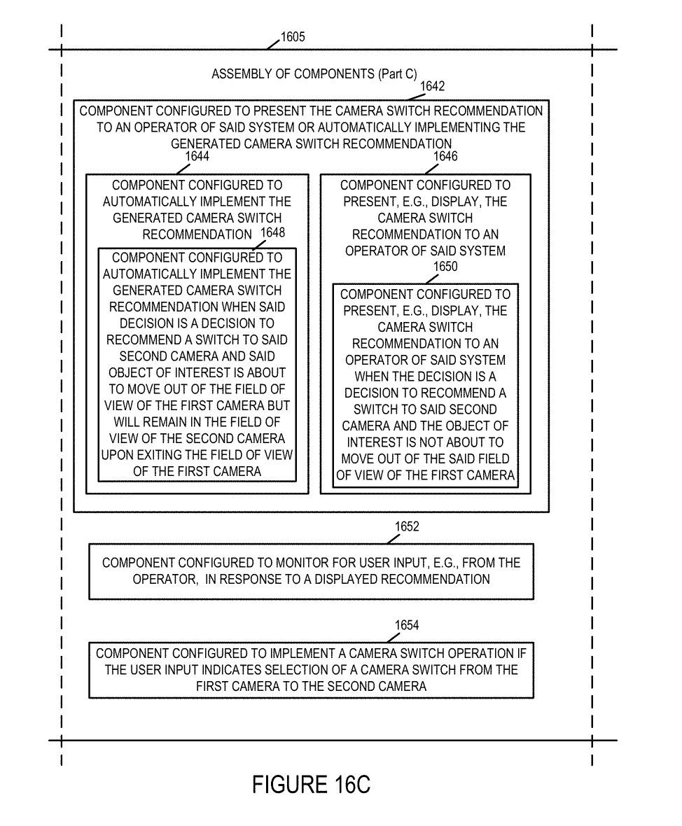

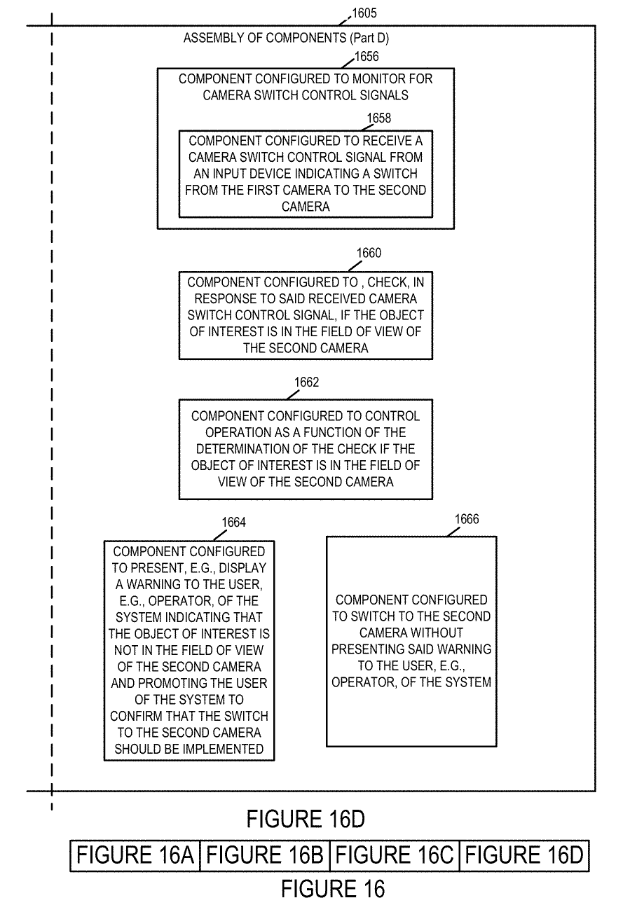

FIG. 16, comprising the combination of FIG. 16A, FIG. 16B, FIG. 16C and FIG. 16D, is a drawing of an assembly of components 1600, comprising the combination of Part A 1601, Part B 1603, Part C 1605 and Part D 1607, in accordance with an exemplary embodiment. Assembly of components 1600 may be including in an exemplary system, e.g., a content delivery system, e.g., content delivery system 104 of FIG. 1, or content delivery system 1100 of FIG. 11, in accordance with an exemplary embodiment.

In one embodiment, exemplary assembly of components 1600 is assembly of components 1150 in system 1100. In one embodiment, exemplary assembly of components 1600 is assembly of components 1152 in memory 1112 of system 1100. In one embodiment, assembly of components 1600 is included in processor 1108. Exemplary assembly of components 1600 is included in an exemplary content delivery system, e.g., any of the exemplary content systems shown and/or described in the Figures and/or corresponding text.

Assembly of components 1600 may be included in an exemplary content and delivery system 1100. The components in the assembly of components 1600 can, and in some embodiments are, implemented fully in hardware within a processor, e.g., processor 1108, e.g., as individual circuits. The components in the assembly of components 1600 can, and in some embodiments are, implemented fully in hardware within the assembly of hardware components 1150, e.g., as individual circuits corresponding to the different components. In other embodiments some of the components are implemented, e.g., as circuits, within processor 1108 with other components being implemented, e.g., as circuits within assembly of components 1150, external to and coupled to the processor 1108. As should be appreciated the level of integration of components on the processor and/or with some components being external to the processor may be one of design choice. Alternatively, rather than being implemented as circuits, all or some of the components may be implemented in software and stored in the memory 1112 of the system 1100, with the components controlling operation of system 1100 to implement the functions corresponding to the components when the components are executed by a processor e.g., processor 1108. In some such embodiments, the assembly of components 1600 is included in the memory 1112 as assembly of software components 1152. In still other embodiments, various components in assembly of components 1600 are implemented as a combination of hardware and software, e.g., with another circuit external to the processor providing input to the processor which then under software control operates to perform a portion of a component's function.

When implemented in software the components include code, which when executed by a processor, e.g., processor 1108, configure the processor to implement the function corresponding to the component. In embodiments where the assembly of components 1600 is stored in the memory 1112, the memory 1112 is a computer program product comprising a computer readable medium comprising code, e.g., individual code for each component, for causing at least one computer, e.g., processor 1108, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 16 control and/or configure the system 1100 or elements therein such as the processor 1108, to perform the functions of corresponding steps illustrated and/or described in the method of one or more of the flowchart 1500 of FIG. 15 and/or described with respect to any of the Figures. Thus the assembly of components 1600 includes various components that perform functions of corresponding one or more described and/or illustrated steps of an exemplary method, e.g., one or more steps of the method of FIG. 15.

Assembly of components 1600 includes a component 2604 configured to perform a monitoring operation, said monitoring operation including at least one of: i) determining a location of an object of interest in an environment or ii) tracking where at least one viewer is looking in said environment, a component 1616 configured to determine if the object of interest is in a field of view of a second camera in addition to being in a field of view of a first camera, a component 1618 configured to decide based on the proximity of the object of interest to an edge of the field of view of the first camera whether the object of interest is about to move out of the field of view of the first camera, and a component 1620 configured to determine a number of monitored viewers turning their heads in a direction towards a main portion of the second camera field of view or away from the main portion of the second camera field of view. Component 1604 includes a component 1610 configured to determine the location of the object of interest, a component 1612 configured to determine a direction of motion of the object of interest, and a component 1614 configured to track where a plurality of viewers, e.g., live spectators in a stadium, are looking in said environment, said at least one viewer being one of the plurality of viewers.

Assembly of components 1600 further includes a component 1624 configured to generate a camera switch recommendation based on information obtained by said monitoring operation. Component 1624 includes a component 1626 configured to make a decision to recommend a switch to said second camera or a recommendation not to switch to said second camera based on whether the object of interest is determined to be in the field of view of the second camera in addition to being in the field of view of said first camera or is determined not to be in the field of view of said second camera in addition to being in said field of view of said first camera. Component 1526 includes a component 1530 configured to generate the camera switch recommendation based on the direction of motion of the object of interest. Component 1630 includes a component 1632 configured to make a decision to recommend a switch to said second camera in response to determining that the object of interest is in the field of view of both the first and second cameras and is moving in a direction of motion out of the field of view of the first camera but which will remain in the field of view of the second camera upon exiting the field of view of the first camera and a component 1634 configured to make a decision to recommend not to switch to said second camera in response to determining that the object of interest is in the field of view of both said first and second cameras and is moving in a direction of motion towards a main portion of the field of view of the first camera. Component 1624 further includes a component 1628 configured to make a decision to recommend a switch to said second camera or a decision not to recommend a switch to said second camera based on the direction in which a majority of monitored viewers are truing their heads as determined from said tracking of where the viewers are looking at the environment. Component 1628 includes a component 1636 configured to make a decision to recommend a switch to said second camera in response to determining that the majority of monitored viewers are turning their heads toward the main portion of the second camera field of view and a component 1638 configured to make a decision not to recommend a switch to said second camera in response to determining that the majority of monitored viewers are turning their heads away from the main portion of the second camera field of view.

Assembly of components 1600 further includes a component 1642 configured to present the camera switch recommendation to an operator of the system or automatically implement the generated camera switch recommendation, a component 1652 configured to monitor for user input, e.g., from the operator of the system, in response to a display recommendation, e.g., a recommendation to switch to said second camera, and a component 1654 configured to implement a camera switch operation if the user input indicates selection of a camera switch from a first camera to the second camera. Component 1642 includes a component 1644 configured to automatically implement the generated camera switch recommendation and a component 1646 configured to present, e.g., display, the camera switch recommendation to an operator of said system. Component 1644 includes a component 1648 configured to automatically implement the generate camera switch recommendation when said decision is a decision to recommend a switch to said second camera and said object of interest is about to move out of the field of view of the first camera but will remain in the field of view of the second camera upon exiting the field of view of the first camera. Component 1646 includes a component 1650 configured to present, e.g., display, the camera switch recommendation to an operator of said second system when the decision is a second to recommend a switch to said second camera and the object of interest is not about to move out of said field of view of the first camera.

Assembly of components 1600 further includes a component 1656 configured to monitor for camera switch control signals. Component 1656 includes a component 1658 configured to receive a first camera switch control signal from an input device indicating a switch from the first camera to the second camera. Assembly of components 1600 further includes a component 1660 configured to check, in response to a received camera switch control signal, if the object of interest is in the field of view of the second camera, a component 1662 configured to control operation as a function of the determination of the check if the object of interest is in the field of view of the second camera, a component 1664 configured to present, e.g., display, a warning to the user, e.g., operator, of the system indicating that the object of interest is not in the field of view of the second camera and promoting the user of the system to confirm that the switch to the second camera should be implemented, and a component 1666 configured to switch to the second camera without presenting said warning to the user, e.g., operator, of the system, e.g., in response to the determination of the check determining that the object of interest is in the field of view of the second camera.

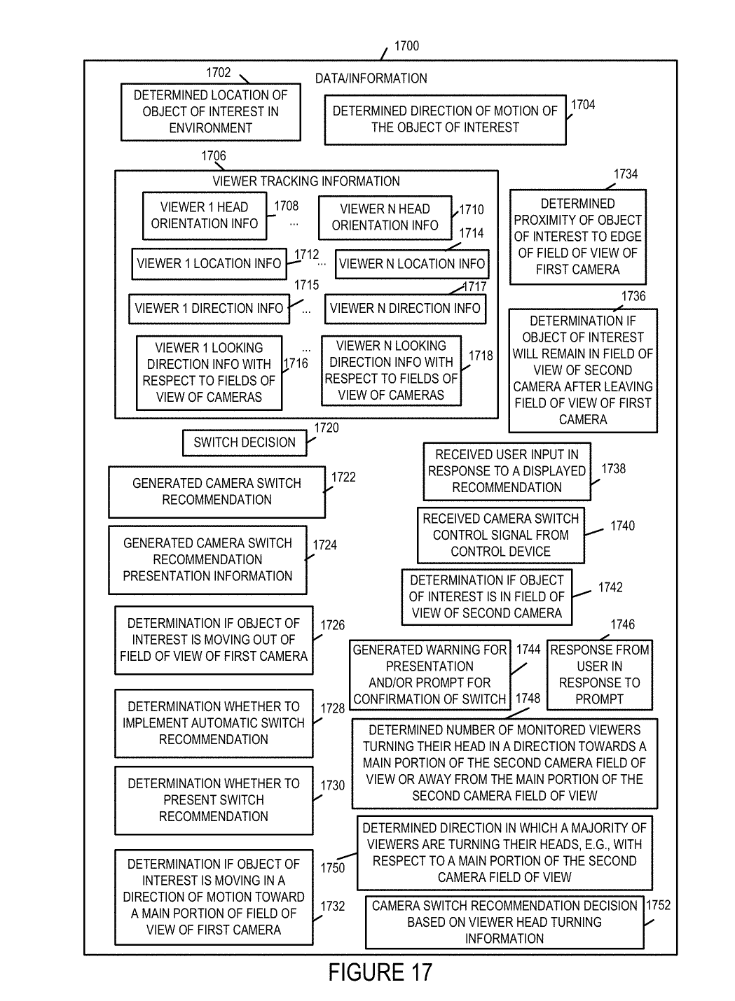

FIG. 17 is a drawing of exemplary data/information 1700 which may be included in an exemplary system, e.g., content delivery system 104 of FIG. 1 or content deliver system 1100 of FIG. 11, in accordance with an exemplary embodiment. Data/information 1700 is, e.g., data/information 1154 of memory 1112 of content delivery system 1100 of FIG. 11.

Exemplary data/information 1700 includes a determined location of an object of interest 1702, a determined direction of motion of the object of interest 1704, and viewer tracking information 1706. The viewer tracking information 1706 corresponds to a plurality of viewers, e.g., live spectators in a stadium, which are wearing a head orientation monitoring and reporting device and whose locations are known or reported. Viewer tracking information 1706 includes viewer 1 head orientation information 1708, viewer 1 location information 1712, viewer 1 direction information 1715, viewer 1 looking direction information with respect to fields of views of cameras in the environment 1716, . . . , viewer 1 head orientation information 1710, viewer N location information 1714, viewer N direction information 1717, viewer N looking direction information with respect to fields of views of cameras in the environment 1718.

Data/information 1700 further includes a switch decision 1720, a generated camera switch recommendation 1722, generated camera switch recommendation presentation information 1724, a determination if the object of interest is moving out of afield of view of the first camera 1726, a determination whether to implement an automatic switch recommendation, a determination whether to present a switch recommendation, e.g., to an operator of the system 1730, a determination if an object of interest is moving in a direction of motion towards a main portion of the field of view of a first camera 1732, a determined proximity of an object of interest to an edge of a field of view of a first camera 1734 and a determination if the object of interest will remain in the filed of view of the second camera after leaving the field of view of the first camera.

Data/information 1700 further includes received user input, e.g., from a system operator, in response to a displayed recommendation 1738, a received camera switch control signal from a control device 1740, a determination if the object of interest is in the field of view of the second camera 1742, a generated warning for presentation and/or prompt for user, e.g., operator, confirmation of a switch 1744, a response from a user, e.g. operator, in response to the prompt 1746, a determined number of monitored viewers turning their heads in a direction towards a main portion of the second camera field of view or away from the main portion of the second camera field of view 1748, a determined direction in which a majority of viewers are turning their heads, e.g., with respect to a main portion of the second camera field of view 1750, and a camera switch recommendation decision based on viewer head turning information 1752.

FIG. 18 is a drawing 1800 illustrating an environment including a playing field 1801, a plurality of camera (camera A 1802, camera B 1804, camera C 1806, camera D 1808, camera E 1810, camera F 1812, camera G 1814, camera H 1816, camera I 1818, camera J 1820, and camera L 1824), and a plurality of headmounted mountoring devices (HMMSs) (HMMD 1 1826, HMMD 2 1828, HMMD 3 1830, HMMD 4 1832, HMMD 5 1834, HMMD 6 1836, HMMD 7 1838, HMMD 8 1840, HMMD 9 1842, HMMD 10 1844, HMMD 11 1846, HMMD 12 1848, HMMD 13 1850, HMMD 14 1854, HMMD 15 1856, HMMD 16 1858, HMMD 17 1860, HMMD 18 1862), and a object of interest 1866, e.g., a ball.

Each of the cameras camera (camera A 1802, camera B 1804, camera C 1806, camera D 1808, camera E 1810, camera F 1812, camera G 1814, camera H 1816, camera I 1818, camera J 1820, and camera L 1824) has a known location, orientation and field of view, and the field of view of each camera overlaps the field of view of at least one other camera. Each of the headmounted monitoring devices HMMSs) (HMMD 1 1826, HMMD 2 1828, HMMD 3 1830, HMMD 4 1832, HMMD 5 1834, HMMD 6 1836, HMMD 7 1838, HMMD 8 1840, HMMD 9 1842, HMMD 10 1844, HMMD 11 1846, HMMD 12 1848, HMMD 13 1850, HMMD 14 1854, HMMD 15 1856, HMMD 16 1858, HMMD 17 1860, HMMD 18 1862) is worn by a viewer, e.g., a live spectator in the stadium at the event, e.g., game.

Each of the head mounted monitoring devices includes sensors, e.g., accelerometers and/or rotary position sensors, e.g., resolvers, synchros, optical rotary position sensor, magnetic rotary position sensor, etc., to determine a user's current head position, e.g., tilt and rotary position with respect to a nominal forward looking straight ahead reference, direction of change of head position, and/or rate of change of head position. In some embodiments, a head mounted monitoring device, e.g., HMMD 1 1826 includes a position determination device, e.g., a GPS receiver, or collects information, e.g., wireless signals used to determine position, to determine a current location of the head of the wearer of the headmounted monitoring device. In other embodiments, the headmounted monitoring device is at a known location, e.g., based on the seat assigned to the wearer of the headmounted mounted monitoring device with a particular ID. The viewer location and/or viewer head orientation information can be determined within the headmounted monitoring device or determined remotely in a server such as streaming server 1864, e.g., based on reported information from the headmounted monitoring device, depending on the particular embodiment. The headmounted monitoring devices (1826, 1828, 1830, 1832, 1834, 1836, 1838, 1840, 1842, 1844, 1846, 1848, 1850, 1854, 1856, 1858, HMMD 17 1860, 1862), are coupled to the streaming server 1864, e.g., via wireless and/or wired communications links. The cameras (1802, 1804, 1806, 1808, 1810, 1812, 1814, 1816, 1818, 1820, and 1824) are also coupled to the streaming server 1864. The streaming server 1864 may be located within the environment or outside of the environment. Streaming server 1864 is, e.g., server 114 of FIG. 1, or content delivery system 104 of FIG. 1 or content delivery system 1100 of FIG. 11.

Each of the headmounted monitoring devices (HMMSs) (HMMD 1 1826, HMMD 2 1828, HMMD 3 1830, HMMD 4 1832, HMMD 5 1834, HMMD 6 1836, HMMD 7 1838, HMMD 8 1840, HMMD 9 1842, HMMD 10 1844, HMMD 11 1848, HMMD 12 1850, HMMD 13 1852, HMMD 14 1854, HMMD 15 1856, HMMD 16 1858, HMMD 17 1860, HMMD 18 1862), has a corresponding current viewer direction as indicated by arrows (1827, 1829, 1831, 1833, 1835, 1837, 1839, 1841, 1843, 1845, 1849, 1851, 1853, 1855, 1857, 1859, 1861, 1863), respectively.

Arrow 1868 indicates the direction of the object of interest 1866, e.g., a ball. It may be observed that the object of interest 1866 is located in the main portion of the field of view of camera B 1804. The number of viewers turning their heads toward the main portion of the field of view of camera B 1804 is 13, which corresponds to HMMDs (1826, 1830, 1832, 1836, 1838, 1840, 1848, 1850, 1852, 1854, 1856, 1860, 1862). Five viewers are turning their heads in different directions. Viewers corresponding to HMMD2 1828 and HMMD5 1834 have a current viewing direction directed toward the main portion of field of view of camera H 1816. Viewers corresponding to HMMD2 1814 and HMMD16 1858 have a current viewing direction directed toward the main portion of field of view of camera D 1808. The viewer corresponding to HMMD9 1843 has a current viewing direction into the stands. Thus the majority of the viewers have turned their heads toward the main portion of the camera B 1804 field of view and the object of interest 1866 is moving in the direction to be more central within the main portion of the camera B field of view.

In various embodiments, spectator viewing tracking information is used, e.g., by streaming server 1864, to make camera switch determinations. In some embodiments, an object of interest's, e.g., object of interest 1866, current location and direction of motion are determined, e.g., in the streaming server 1864, e.g., based on received images from the cameras, and camera switch recommendations are made, presented, and/or automatically implemented based on the known camera locations, known camera orientations, and known camera fields of view. In some embodiments, both spectator viewing direction information and object of interest information are used to make camera switch recommendations and/or decisions.

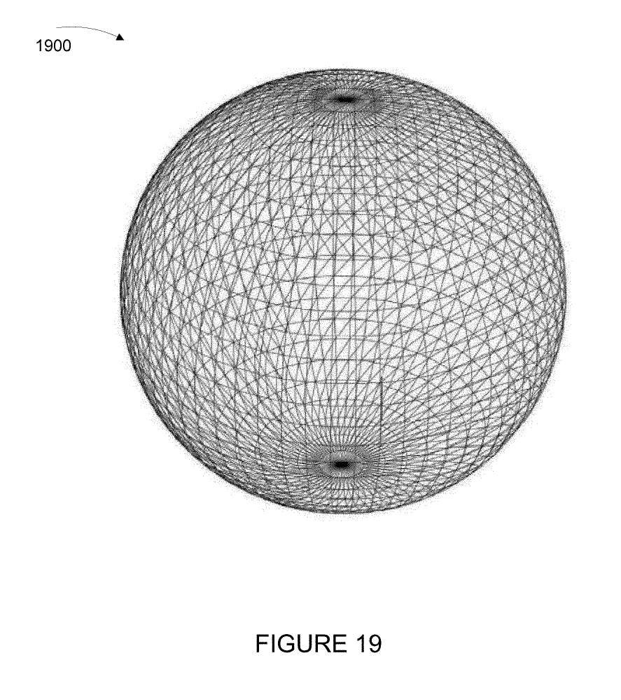

FIG. 19 shows an exemplary mesh model 1900 of an environment which can be used in various embodiments. While a spherical environment is shown for purposes of explaining the invention, in the case where the environment is the interior of a stadium, the mesh model would have the same of the interior of the stadium. Note that the mesh model of the environment includes a plurality of segments.

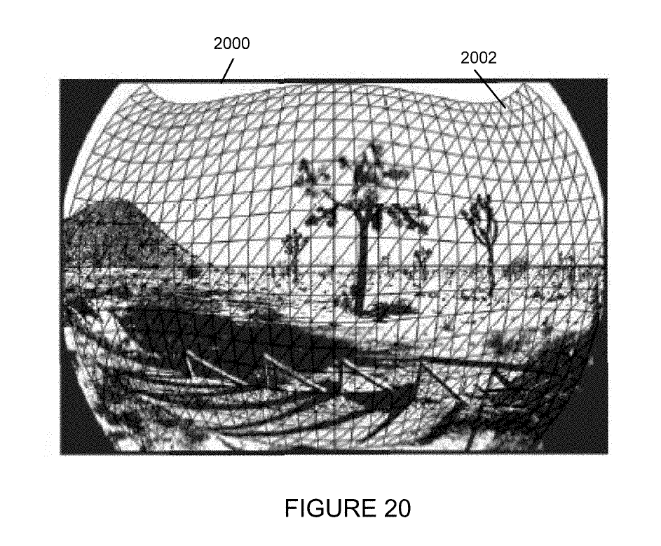

FIG. 20 shows an image 2000 captured by a camera with a UV map in the form of a grid 2002 superimposed thereon. There is a predefined mapping between segments of the UV map 2002 and segments of the environmental model 1900. The UV map 2002 in FIG. 20 is not uniform because it takes into consideration distortions caused by a fisheye camera lens used to capture the image 2000 of the environment. Given the mapping of a segment of the UV map to a segment of the 3D environmental model, the UV map provides information on how to apply portions of the image 2000 to the environmental model 1900 as a texture.

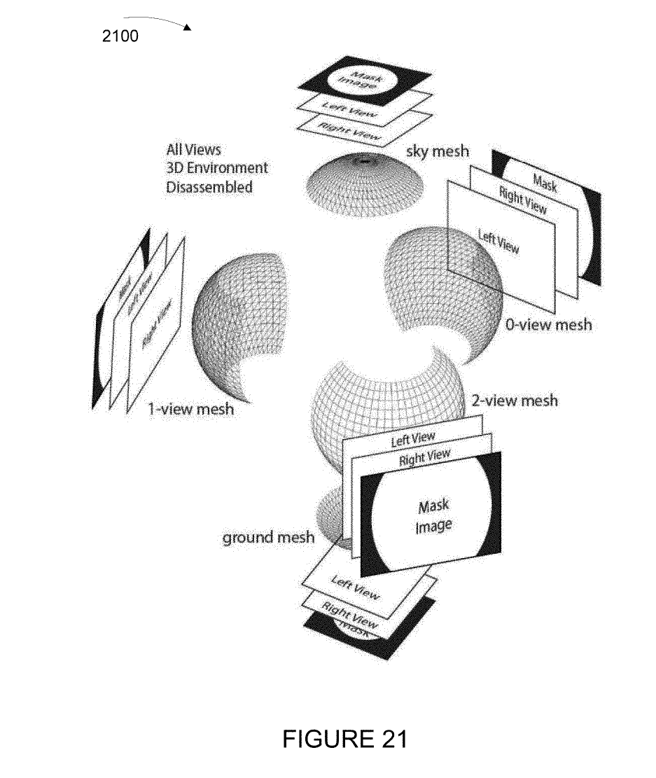

FIG. 21 is an diagram 2100 showing how left and right eye views captured by cameras of different stereoscopic pairs directed towards different portions of the environment can be applied to corresponding portions of the 3D mesh model of the environment shown in FIG. 19 with UV maps for each of the captured images providing guidance on how to apply a particular image as a texture to the corresponding portion of the 3D mesh model. While masks are used in some embodiments the use of a mask is optional. While left and right eye images are shown being applied to the model it should be appreciated that different left and right eye view images are created during rendering and displayed to a playback device user's left and right eyes, respectively. Thus while it might appear in FIG. 21 that the left and right eye views are superimposed this is not the case with rendered left and right eye images being generated separately and then displayed.

In various embodiments a portion of an environment to be displayed to a user at a given time is determined based on a user's head orientation which determines a field of view of the environment to be presented to the user in a rendered image. A rendered image to be displayed to the user is generated by the playback device applying portions of one or more received images, e.g., images of the real world environment captured by a camera or cameras, as textures to the environmental mesh model in accordance with a UV map or UV maps. The resulting rendered image of the environment is then displayed to the user of the playback device. Different left and right eye views are displayed.

The UV map used in the rendering process depends on which camera captured the image that is being used as a texture. Accordingly, when a camera switch occurs a switch in the UV map or maps used as part of the rendering process will occur so that the UV maps corresponding to the camera which is the source of an image being used as a texture will be used in the rendering process.

### First Numbered List of Exemplary Embodiments

### Method Embodiment 1

A method of operating a playback system, the method comprising: displaying, on a display, a portion of a first image of an environment, said first image having been captured by a first camera; determining a first user point of view in the environment based on: i) a first camera location, ii) a first camera current point of view; and iii) a current head orientation of a user of the playback system; identifying a location on a model of the environment corresponding to said determined first user point of view; and displaying a portion of a second image of the environment captured by a second camera on the display, said portion of the second image including second image content corresponding (e.g. mapping based on a UV map) to the identified location.

### Method Embodiment 2

The method of Method Embodiment, wherein said first camera location is a first location in said environment, said first location being the location of said first camera in said environment.

### Method Embodiment 3

The method of Method Embodiment 1, further comprising: determining the portion of the second image of the environment (e.g., including the identified location) to display based on: i) a second camera location and ii) a second camera current point of view.

### Method Embodiment 4

The method of Method Embodiment 3, wherein said first camera location and said second camera locations are locations in a sports stadium or concert venue.

### Method Embodiment 5

The method of Method Embodiment 3, further comprising: receiving a switch signal indicating a switch from the first camera to the second camera, said first and second cameras being located at different locations but having overlapping fields of view.

### Method Embodiment 6

The method of Method Embodiment 5, further comprising: in response to said switch signal switching from outputting, to the display, image content captured by the first camera to outputting, to the display, image content captured by the second camera, said step of displaying the portion of the second image being performed as part of outputting image content captured by the second camera.

### Method Embodiment 7

The method of Method Embodiment 6, wherein said step of displaying the portion of the second image includes: displaying image content captured by the second camera corresponding to the identified location on the model of the environment on the same portion of the display used, prior to said switch, to display image content captured by the first camera corresponding to the identified location on the model of the environment.

### Method Embodiment 8

The method of Method Embodiment 7, wherein said first camera is a first camera of a first stereoscopic camera pair including a left eye camera and a right eye camera used to capture left and right eye images, respectively; wherein said second camera is a first camera of a second stereoscopic camera pair including a left eye camera and a right eye camera used to capture left and right eye images, respectively; and wherein said same portion of the display is a portion located at the center of one of a left portion of the display used to display a left eye image and a right portion of the display used to display a right eye image.

### Method Embodiment 9

The method of Method Embodiment 2, wherein said model of the environment is a mesh model; and wherein said identified location is a location of a node in said mesh model.

### Method Embodiment 10

The method of Method Embodiment 2, wherein said model of the environment is a 3D model.

### Method Embodiment 11

The method of Method Embodiment 9, wherein displaying the portion of the first image of the environment includes: i) performing a first image rendering operation, said first image rendering operation including applying said first image of the environment to the mesh model in accordance with a first UV map mapping portions of images captured by said first camera to portions of said mesh model to generate a rendered first image including said portion of the first image of the environment; and ii) displaying said rendered first image on the display; and wherein displaying the portion of the second image of the environment includes: i) performing a second image rendering operation, said second image rendering operation including applying said second image of the environment to the mesh model in accordance with a second UV map mapping portions of images captured by said second camera to portions of said mesh model to generate a rendered second image including said portion of the second image of the environment; and ii) displaying said rendered second image on the display.

### Method Embodiment 12

The method of Method Embodiment 3, wherein determining a first user point of view in the environment based on: i) a first camera location, ii) a first camera current point of view; and iii) a current head orientation of a user of the playback system includes: using ray tracing and knowledge of an effect of a lens of the first camera to determine the first user point of view.

### Method Embodiment 13

The method of Method Embodiment 12, wherein said lens of the first camera is a fish eye lens; and wherein said ray tracing takes into consideration the distortions introduced by said fish eye lens into images captured by said first camera.

### Method Embodiment 14

The method of Method Embodiment 13, wherein the second camera also uses a fisheye lens.

### Method Embodiment 15

The method of Method Embodiment 13, further comprising: determining the first camera point of view from a first default camera orientation and first information indicating a director controlled change in first camera orientation from said first default camera orientation; and determining the second camera point of view from a second default camera orientation and second information indicating a director controlled change in second camera orientation from said second default camera orientation.

### Method Embodiment 16

The method of Method Embodiment 15, further comprising: receiving said first default camera orientation and first information indicating a director controlled change in first camera orientation in a first content stream including images captured by said first camera, said images captured by said first camera including said first image.

### Method Embodiment 17

The method of Method Embodiment 16, further comprising: receiving said second default camera orientation and second information indicating a director controlled change in second camera orientation in a second content stream including images captured by said second camera, said images captured by said second camera including said second image.

### System Embodiment 18

A playback system (1200), comprising: a display (1202); a receiver (1231) configured to receive content including captured images; memory (1212); and a processor (1208) coupled to said memory (1208), said processor (1208) being configured to control the playback system (1200) to: display, on the display, a portion of a first image of an environment, said first image having been captured by a first camera; determine a first user point of view in the environment based on: i) a first camera location, ii) a first camera current point of view; and iii) a current head orientation of a user of the playback system; identify a location on a model of the environment corresponding to said determined first user point of view; and display a portion of a second image of the environment captured by a second camera on the display, said portion of the second image including second image content corresponding (e.g. mapping based on a UV map) to the identified location.

### System Embodiment 19

The playback system (1200) of System Embodiment 18, wherein said first camera location is a first location in said environment, said first location being the location of said first camera in said environment.

### System Embodiment 20

The playback system (1200) of System Embodiment 18, wherein the processor (1208) is further configured to: determine the portion of the second image of the environment (e.g., including the identified location) to display based on: i) a second camera location and ii) a second camera current point of view.

### System Embodiment 21

The playback system (1200) of System Embodiment 3, wherein said first camera location and said second camera location are locations in a sports stadium or concert venue.

### System Embodiment 22

The playback system (1200) of System Embodiment 20, wherein the receiver (1231) is further configured to: receive a switch signal indicating a switch from the first camera to the second camera, said first and second cameras being located at different locations but having overlapping fields of view.

### System Embodiment 23

The playback system (1200) of System Embodiment 22, wherein the playback system (1200) is further configured to control the playback system (1200) to: in response to said switch signal, switch from outputting to the display, image content captured by the first camera to outputting, to the display, image content captured by the second camera, said step of displaying the portion of the second image being performed as part of outputting image content captured by the second camera.

### System Embodiment 24

The playback system (1200) of System Embodiment 23, wherein the processor (1208) is configured, as part of displaying the portion of the second image to: display image content captured by the second camera corresponding to the identified location on the model of the environment on the same portion of the display used, prior to said switch, to display image content captured by the first camera corresponding to the identified location on the model of the environment.

### System Embodiment 25

The playback system (1200) of System Embodiment 24, wherein said first camera is a first camera of a first stereoscopic camera pair including a left eye camera and a right eye camera used to capture left and right eye images, respectively; wherein said second camera is a first camera of a second stereoscopic camera pair including a left eye camera and a right eye camera used to capture left and right eye images, respectively; and wherein said same portion of the display is a portion located at the center of one of a left portion of the display used to display a left eye image and a right portion of the display used to display a right eye image.

### System Embodiment 26

The playback system (1200) of System Embodiment 19, wherein said model of the environment is a mesh model; and wherein said identified location is a location of a node in said mesh model.

### System Embodiment 27

The playback system (1200) of System Embodiment 19, wherein said model of the environment is a 3D model.

### System Embodiment 28

The playback system (1200) of System Embodiment 26, wherein the processor (1208) is configured to control the playback system (1200), as part of displaying the portion of the first image of the environment, to: i) perform a first image rendering operation, said first image rendering operation including applying said first image of the environment to the mesh model in accordance with a first UV map mapping portions of images captured by said first camera to portions of said mesh model to generate a rendered first image including said portion of the first image of the environment; and ii) display said rendered first image on the display; and wherein the processor (1208) is further configured to control the playback system (1200), as part of displaying the portion of the second image of the environment to: i) perform a second image rendering operation, said second image rendering operation including applying said second image of the environment to the mesh model in accordance with a second UV map mapping portions of images captured by said second camera to portions of said mesh model to generate a rendered second image including said portion of the second image of the environment; and ii) display said rendered second image on the display.

### System Embodiment 29

The playback system (1200) of System Embodiment 21, wherein as part of determining a first user point of view in the environment based on: i) a first camera location, ii) a first camera current point of view; and iii) a current head orientation of a user of the playback device, the processor controls the playback device to: use ray tracing and knowledge of an effect of a lens of the first camera to determine the first user point of view.

### System Embodiment 30

The playback system (1200) of System Embodiment 29, wherein said lens of the first camera is a fish eye lens; and wherein said ray tracing takes into consideration the distortions introduced by said fish eye lens into images captured by said first camera.

### System Embodiment 31

The playback system (1200) of System Embodiment 30, wherein the second camera also uses a fisheye lens.

### System Embodiment 32

The playback system (1200) of System Embodiment 30, wherein the processor (1208) is configured to control the playback system (1200) to: determine the first camera point of view from a first default camera orientation and first information indicating a director controlled change in first camera orientation from said first default camera orientation; and determine the second camera point of view from a second default camera orientation and second information indicating a director controlled change in second camera orientation from said second default camera orientation.

### System Embodiment 33

The playback system (1200) of System Embodiment 32, wherein the receiver (1231) is further configured to: receive said first default camera orientation and first information indicating a director controlled change in first camera orientation in a first content stream including images captured by said first camera, said images captured by said first camera including said first image.

### System Embodiment 34

The playback system (1200) of System Embodiment 33, wherein said receiver (1231) is further configured to: receive said second default camera orientation and second information indicating a director controlled change in second camera orientation in a second content stream including images captured by said second camera, said images captured by said second camera including said second image.

### Second Numbered List of Exemplary Embodiments

### Method Embodiment 1

A method of operating a system, the method comprising: performing (1504) a monitoring operation (e.g., monitor where an object of interest is or where viewers in the environment are looking), said monitoring operation including at least one of: i) determining (1510) a location of an object (e.g. person or ball) of interest in an environment (e.g., in a stadium or theater); or ii) tracking (1514) where at least one viewer (e.g., spectator in the stadium) is looking in said environment; generating (1524) a camera switch recommendation (e.g., for a streaming system server operator who controls streaming of content to end users watching a sports game) based on information (e.g., object of interest location and/or direction of movement) obtained by said monitoring operation; and presenting (1542) the camera switch recommendation to an operator of said system or automatically implementing the generated camera switch recommendation.

### Method Embodiment 2

The method of Method Embodiment 1, wherein said monitoring operation (1504) includes determining (1510) the location of the object of interest, the method further comprising: determining (1516) if the object of interest is in a field of view of a second camera in addition to being in a field of view of said first camera; and wherein generating (1524) the camera switch recommendation includes making (1526) a decision to recommend a switch to said second camera or a recommendation not to switch to said second camera based on whether the object of interest is determined to be in the field of view of the second camera in addition to being in the field of view of said first camera or is determined not be in the field of view of a second camera in addition to being in said field of view of said first camera.

### Method Embodiment 3

The method of Method Embodiment 2, wherein said monitoring (1504) operation further includes: determining (1512) a direction of motion of the object of interest.

### Method Embodiment 4

The method of Method Embodiment 3, wherein generating (1524) the camera switch recommendation is further based on the direction of motion of the object of interest (1530).

### Method Embodiment 5

The method of Method Embodiment 4, wherein generating (1524) the camera switch recommendation includes: i) making (1532) a decision to recommend a switch to said second camera in response to determining that the object of interest is in the field of view of both said first and second cameras and is moving in a direction of motion out of said field of view of the first camera but which will remain in the field of view of the second camera upon exiting the field of view of the first camera; and ii) making (1534) a decision to recommend not to switch to said second camera in response to determining that the object of interest is in the field of view of both said first and second cameras and is moving in a direction of motion towards a main portion of the field of view of the first camera.

### Method Embodiment 6

The method of Method Embodiment 5, wherein the method further includes: automatically implementing (1548) the generated camera switch recommendation when said decision is a decision to recommend a switch to said second camera and the object of interest is about to move out of said field of view of the first camera but will remain in the field of view of the second camera upon exiting the field of view of the first camera.

### Method Embodiment 7

The method of Method Embodiment 5, wherein the method includes presenting (1550) (e.g., displaying on a control system display) the camera switch recommendation to the operator of said system when said decision is a decision to recommend a switch to said second camera and the object of interest is not about to move out of said field of view of the first camera.

### Method Embodiment 8

The method of Method Embodiment 7, further comprising: deciding (1518) based on the proximity of the object of interest to an edge of the field of view of the first camera whether the object of interest is about to move out of the field of view of the first camera.

### Method Embodiment 9

The method of Method Embodiment 7, further comprising: monitoring (1552) for user input, e.g., from the operator, in response to a displayed recommendation; and implementing (1554) a camera switch operation if the user input indicates selection of a camera switch from the first camera to the second camera.

### Method Embodiment 10

The method of Method Embodiment 1, further comprising: receiving (1558) a camera switch control signal from an input device indicating a switch from said first camera to said second camera; in response to said camera switch control signal, checking (1560) if the object of interest is in the field of view of the second camera; and if it is determined that the object of interest is not in the field of view of the second camera, presenting (1564) (e.g., displaying) a warning to the user, e.g., operator, of the system indicating that the object of interest is not in the field of view of the second camera and promoting the user of the system to confirm that the switch to the second camera should be implemented.

### Method Embodiment 11

The method of Method Embodiment 10, further comprising: if it is determined that the object of interest is in the field of view of the second camera, switching (1566) to the second camera without presenting said warning to the user of the system.

### Method Embodiment 12

The method of Method Embodiment 1, wherein said monitoring operation (1504) includes tracking (1514) where a plurality of viewers (e.g., live spectator in the stadium) are looking in said environment, said at least one viewer being one of said plurality of viewers; and wherein generating (1524) the camera switch recommendation includes making (1528) a decision to recommend a switch to said second camera or a decision not to recommend a switch to said second camera based on the direction in which a majority of monitored viewers are turning their head as determined from said tracking of where the viewers are looking in the environment.

### Method Embodiment 13

The method of Method Embodiment 12, further comprising: determining (1520) a number of monitored viewers turning their head in a direction towards a main portion of the second camera field of view or away from the main portion of the second camera field of view.

### Method Embodiment 14

The method of Method Embodiment 13, wherein making (1528) the camera switch recommendation includes: i) making (1536) a decision to recommend a switch to said second camera in response to determining that the majority of monitored viewers are turning their head toward the main portion of the second camera field of view; and ii) making (1538) a decision not to recommend a switch to said second camera in response to determining that the majority of monitored viewers are turning their head away from the main portion of the second camera field of view.

### System Embodiment 15

A system (1100) comprising: a receiver (1141) for receiving image content captured by at least first and second cameras in an environment; a control apparatus (1101) including a processor (1108) configured to: perform a monitoring operation (e.g., monitor where an object of interest is or where viewers in the environment are looking), said monitoring operation including at least one of: i) determining a location of an object (e.g. person or ball) of interest in an environment (e.g., in a stadium or theater); or ii) tracking where at least one viewer (e.g., spectator in the stadium) is looking in said environment; and generate a camera switch recommendation (e.g., for streaming system server operator who controls streaming of content to end users watching a sports game) based on information (e.g., object of interest location and/or direction of movement) obtained by said monitoring operation; and present the camera switch recommendation to an operator of said control apparatus (1101) or automatically implement the generated camera switch recommendation.

### System Embodiment 16

The system (1100) of System Embodiment 15, wherein said processor (1108) is further configured, as part of said monitoring operation, to determining the location of the object of interest; and wherein said processor (1108) is further configured to determine if the object of interest is in a field of view of a second camera in addition to being in a field of view of said first camera; and wherein the processor (1108) is also further configured, as part of generating the camera switch recommendation, to make a decision to recommend a switch to said second camera or a recommendation not to switch to said second camera based on whether the object of interest is determined to be in the field of view of the second camera in addition to being in the field of view of said first camera or is determined not be in the field of view of a second camera in addition to being in said field of view of said first camera.

### System Embodiment 17

The system (1100) of System Embodiment 16, wherein said processor (1108) is further configured, as part of performing the monitoring operation to: determine a direction of motion of the object of interest.

### System Embodiment 18

The system (1100) of System Embodiment 17, wherein generating the camera switch recommendation is further based on the direction of motion of the object of interest.

### System Embodiment 19

The system (1100) of System Embodiment 18, wherein the processor (1108) is further configured, as part of generating the camera switch recommendation to: i) make a decision to recommend a switch to said second camera in response to determining that the object of interest is in the field of view of both said first and second cameras and is moving in a direction of motion out of said field of view of the first camera but which will remain in the field of view of the second camera upon exiting the field of view of the first camera; and ii) make a decision to recommend not to switch to said second camera in response to determining that the object of interest is in the field of view of both said first and second cameras and is moving in a direction of motion towards a main portion of the field of view of the first camera.

### System Embodiment 20

The system (1100) of System Embodiment 19, wherein the processor (1108) is further configured to: automatically implement the generated camera switch recommendation when said decision is a decision to recommend a switch to said second camera and the object of interest is about to move out of said field of view of the first camera but will remain in the field of view of the second camera upon exiting the field of view of the first camera.

### System Embodiment 21

The system (1100) of System Embodiment 19, further including: a display (1102); and wherein the processor (1108) is further configured to: present (e.g., displaying on a control system display) the camera switch recommendation to the operator of said system when said decision is a decision to recommend a switch to said second camera and the object of interest is not about to move out of said field of view of the first camera.

### System Embodiment 22

The system (1100) of System Embodiment 21, wherein the processor (1108) is further configured to: decide based on the proximity of the object of interest to an edge of the field of view of the first camera whether the object of interest is about to move out of the field of view of the first camera.

### System Embodiment 23

The system (1100) of System Embodiment 21, wherein the processor is further configured to: monitor for user input from an operator of the system, in response to a displayed recommendation; and implement a camera switch operation if the user input indicates selection of a camera switch from the first camera to the second camera.

### System Embodiment 24

The system (1100) of System Embodiment 15, further comprising: an input device (1104) configured to receive a camera switch control signal indicating a switch from said first camera to said second camera; and wherein the processor (1108) is further configured, to: check if the object of interest is in the field of view of the second camera in response to said camera switch control signal; and present, if it is determined that the object of interest is not in the field of view of the second camera, (e.g., display) a warning to the user, e.g., operator, of the system indicating that the object of interest is not in the field of view of the second camera and promoting the user of the system to confirm that the switch to the second camera should be implemented.

### System Embodiment 25

The system (1100) of System Embodiment 24, wherein the processor (1108) is further configured to: control said system (1100) to switch to streaming the content from the second camera without presenting said warning to the user of the system, if it is determined that the object of interest is in the field of view of the second camera.

### System Embodiment 26

The system (1100) of System Embodiment 15, wherein said processor (1108) is configured, as part of performing said monitoring operation to: track where a plurality of viewers (e.g., live spectator in the stadium) are looking in said environment, said at least one viewer being one of said plurality of viewers; and as part of generating the camera switch recommendation, make a decision to recommend a switch to said second camera or a decision not to recommend a switch to said second camera based on the direction in which a majority of monitored viewers are turning their head as determined from said tracking of where the viewers are looking in the environment.

### System Embodiment 27

The system (1100) of System Embodiment 26, wherein the processor (1108) is further configured to: determine a number of monitored viewers turning their head in a direction towards a main portion of the second camera field of view or away from the main portion of the second camera field of view.

### System Embodiment 28

The system (1100) of System Embodiment 27, wherein said processor (1108) is configured, as part of making the camera switch recommendation, to: i) make a decision to recommend a switch to said second camera in response to determining that the majority of monitored viewers are turning their head toward the main portion of the second camera field of view; and ii) make a decision not to recommend a switch to said second camera in response to determining that the majority of monitored viewers are turning their head away from the main portion of the second camera field of view.

An exemplary method of presenting content corresponding to an environment, in accordance with some embodiments comprises: displaying to a user content corresponding to a first camera position in said environment; determining if the user is viewing another camera position in said environment; and monitoring, while said user is viewing said another camera position, to detect user input indicating a user selected switch to said another camera position. In some embodiments the determining if the user is viewing another camera position in said environment includes determining from i) a user head angle of rotation, ii) user head tilt angle or iii) both the user head angle of rotation and user head tilt angle, if said user is viewing said another camera position.

In some embodiments the method further comprises: determining which of a plurality of alternative camera positions the user is viewing based on at least one of the user head angle of rotation or viewer head tilt angle. In some embodiments the method further comprises: when it is determined that the user is viewing another camera position in said environment, presenting the user an indication that the user can switch to viewing the environment from a perspective of said another camera position.

In some embodiments the presenting the user an indication that the user can switch to viewing the environment from a perspective of said another camera position includes providing a visual indication corresponding to the another camera position that a switch to viewing the environment from the perspective of said another camera position is possible. In some embodiments the visual indication is one of at least a change in color or shading at the another camera position. In some embodiments the visual indication includes text in the area of said another camera position putting the user on notice of the potential to switch to viewing from the perspective of said another camera position. In some embodiments the another camera position is one of a second, third or fourth camera position at a stadium. In some embodiments the environment is a stadium or area. In some embodiments the environment includes an audience seating area and a performance area said environment including at least two camera positions corresponding to different audience seating positions. In some embodiments the performance area is one of a field or a stage.

In some embodiments the method further comprises: in response to said monitoring detecting user input indicating a user selected switch to said another camera position switching from displaying to the user content corresponding to a first camera position in said environment to displaying to the user content corresponding to the another camera position in said environment.

In some embodiments switching from displaying to the user content corresponding to a first camera position in said environment includes switching from receiving and displaying a first broadcast content stream corresponding to an output of a first stereoscopic camera pair located at said first camera position to receiving and displaying a second broadcast content stream corresponding to an output of a second stereoscopic camera pair located at said another camera position.

In some embodiments the monitoring to detect user input indicating a user selected switch to said another camera position includes monitoring for user input on a control input interface (e.g., touch pad or touch screen) while said user is viewing said another camera position. In some embodiments the user input includes one or a double tap on the control input while the user is viewing the another camera position. In some embodiments determining if the user is viewing another camera position in said environment includes: monitoring a current head orientation of the user; and determining if the head orientation indicates (e.g., by the angle relative to the camera position of the current view) whether the user is viewing the another camera position.

In some embodiments the method further comprises: determining, prior to presenting the user an indication that the user can switch to viewing the environment from a perspective of said another camera position, if the user was viewing said another camera position for a predetermined time. In some embodiments presenting the user said indication is contingent on determining that the user was viewing said another camera position for the predetermined time.

In some embodiments the method further comprises: eliminating the indication that the user can switch to viewing the environment from a perspective of said another camera position if said monitoring, while said user is viewing said another camera position, fails to detect user input indicating a user selected switch to said another camera position within a predetermined time of the start of presenting the user the indication.

An exemplary interactive system, e.g., such as the rendering and playback system 1200, for presenting content corresponding to an environment, comprises: a display device; a display controller configured to control displaying, to a user on said display device, of content corresponding to a first camera position in said environment; a user view determination module configured to determine if the user is viewing another camera position in said environment; and a monitoring module configured to monitor, while said user is viewing said another camera position, to detect user input indicating a user selected switch to said another camera position.

In some embodiments the user view determination module is configured to determine from i) a user head angle of rotation, ii) user head tilt angle or iii) both the user head angle of rotation and user head tilt angle, if said user is viewing said another camera position. In some embodiments the system further comprises: a camera position determination module configured to determine which of a plurality of alternative camera positions the user is viewing based on at least one of said user head angle of rotation or user head tilt angle.

In some embodiments the system the display controller is further configured to control presenting, on said display device, of an indication to the user that the user can switch to viewing the environment from a perspective of said another camera position when it is determined that the user is viewing another camera position in said environment. In some embodiments the display controller is further configured to control presenting of a visual indication corresponding to the another camera position, on said display device, indicating that a switch to viewing the environment from the perspective of said another camera position is possible, as part of being configured to present the user an indication that the user can switch to viewing the environment from a perspective of said another camera position.

In some embodiments the system further comprises: a switch controller configured to control the system to switch from displaying, on said display device, content corresponding to a first camera position in said environment to displaying to the user content corresponding to the another camera position in said environment, in response to said monitoring module detecting user input indicating a user selected switch to said another camera position. In some embodiments the switch controller is further configured, as part of being configured to switch from displaying content corresponding to a first camera position to displaying content corresponding to said another camera position, to control the system to switch from receiving and displaying a first broadcast content stream corresponding to an output of a first stereoscopic camera pair located at said first camera position to receiving and displaying a second broadcast content stream corresponding to an output of a second stereoscopic camera pair located at said another camera position.

In some embodiments the system further comprises: a control input interface. In some embodiments the monitoring module is configured to monitor to detect user input indicating a user selected switch to said another camera position on said control input interface while said user is viewing said another camera position.

In some embodiments the user view determination module is further configured to: monitor the current head orientation of the user; and determine if the head orientation indicates whether the user is viewing the another camera position. In some embodiments the system further comprises: a timer configured to determine if the user was viewing said another camera position for a predetermined time. In some embodiments the display controller is configured to control presenting, on said display device, of said indication to the user that the user can switch to viewing the environment from a perspective of said another camera position contingent upon a determination by said timer that the user was viewing said another camera position for the predetermined time. In some embodiments the display controller is configured to eliminate the indication that the user can switch to viewing the environment from a perspective of said another camera position if said monitoring module fails to detect user input indicating a user selected switch to said another camera position within a predetermined time of the start of presenting the user the indication.

Some embodiments are directed a non-transitory computer readable medium embodying a set of software instructions, e.g., computer executable instructions, for controlling a computer or other device to encode and compresses stereoscopic video. Other embodiments are embodiments are directed a computer readable medium embodying a set of software instructions, e.g., computer executable instructions, for controlling a computer or other device to decode and decompresses video on the player end. While encoding and compression are mentioned as possible separate operations, it should be appreciated that encoding may be used to perform compression and thus encoding may, in some include compression. Similarly, decoding may involve decompression.

The techniques of various embodiments may be implemented using software, hardware and/or a combination of software and hardware. Various embodiments are directed to apparatus, e.g., a image data processing system. Various embodiments are also directed to methods, e.g., a method of processing image data. Various embodiments are also directed to a non-transitory machine, e.g., computer, readable medium, e.g., ROM, RAM, CDs, hard discs, etc., which include machine readable instructions for controlling a machine to implement one or more steps of a method.

Various features of the present invention are implemented using modules. Such modules may, and in some embodiments are, implemented as software modules. In other embodiments the modules are implemented in hardware. In still other embodiments the modules are implemented using a combination of software and hardware. In some embodiments the modules are implemented as individual circuits with each module being implemented as a circuit for performing the function to which the module corresponds. A wide variety of embodiments are contemplated including some embodiments where different modules are implemented differently, e.g., some in hardware, some in software, and some using a combination of hardware and software. It should also be noted that routines and/or subroutines, or some of the steps performed by such routines, may be implemented in dedicated hardware as opposed to software executed on a general purpose processor. Such embodiments remain within the scope of the present invention. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods. Accordingly, among other things, the present invention is directed to a machine-readable medium including machine executable instructions for causing a machine, e.g., processor and associated hardware, to perform one or more of the steps of the above-described method(s).

Numerous additional variations on the methods and apparatus of the various embodiments described above will be apparent to those skilled in the art in view of the above description. Such variations are to be considered within the scope.

What is claimed is:

1. A method of operating a system, the method comprising:
performing a monitoring operation, said monitoring operation including at least one of:
i) determining a location of an object of interest in an environment; or
ii) tracking where at least one viewer is looking in said environment;
generating a camera switch recommendation based on information obtained by said monitoring operation; and
presenting the camera switch recommendation to an operator of said system or automatically implementing the generated camera switch recommendation.

2. The method of claim 1, wherein said monitoring operation includes determining the location of the object of interest, the method further comprising:
determining if the object of interest is in a field of view of a second camera in addition to being in a field of view of said first camera; and
wherein generating the camera switch recommendation includes making a decision to recommend a switch to said second camera or a recommendation not to switch to said second camera based on whether the object of interest is determined to be in the field of view of the second camera in addition to being in the field of view of said first camera or is determined not be in the field of view of a second camera in addition to being in said field of view of said first camera.

3. The method of claim 2, wherein said monitoring operation further includes:
determining a direction of motion of the object of interest.

4. The method of claim 3, wherein generating the camera switch recommendation is further based on the direction of motion of the object of interest.

5. The method of claim 4, wherein generating the camera switch recommendation includes:
i) making a decision to recommend a switch to said second camera in response to determining that the object of interest is in the field of view of both said first and second cameras and is moving in a direction of motion out of said field of view of the first camera but which will remain in the field of view of the second camera upon exiting the field of view of the first camera; and
ii) making a decision to recommend not to switch to said second camera in response to determining that the object of interest is in the field of view of both said first and second cameras and is moving in a direction of motion towards a main portion of the field of view of the first camera.

6. The method of claim 5, wherein the method further includes:
automatically implementing the generated camera switch recommendation when said decision is a decision to recommend a switch to said second camera and the object of interest is about to move out of said field of view of the first camera but will remain in the field of view of the second camera upon exiting the field of view of the first camera.

7. The method of claim 5, wherein the method includes presenting the camera switch recommendation to the operator of said system when said decision is a decision to recommend a switch to said second camera and the object of interest is not about to move out of said field of view of the first camera.

8. The method of claim 7, further comprising:
deciding based on the proximity of the object of interest to an edge of the field of view of the first camera whether the object of interest is about to move out of the field of view of the first camera.

9. The method of claim 1, further comprising:
receiving a camera switch control signal from an input device indicating a switch from said first camera to said second camera;
in response to said camera switch control signal, checking if the object of interest is in the field of view of the second camera; and
if it is determined that the object of interest is not in the field of view of the second camera, presenting a warning to the user of the system indicating that the object of interest is not in the field of view of the second camera and promoting the user of the system to confirm that the switch to the second camera should be implemented.

10. The method of claim 9, further comprising:
if it is determined that the object of interest is in the field of view of the second camera, switching to the second camera without presenting said warning to the user of the system.

11. The method of claim 1, wherein said monitoring operation includes tracking where a plurality of viewers are looking in said environment, said at least one viewer being one of said plurality of viewers; and
wherein generating the camera switch recommendation includes making a decision to recommend a switch to said second camera or a decision not to recommend a switch to said second camera based on the direction in which a majority of monitored viewers are turning their head as determined from said tracking of where the viewers are looking in the environment.

12. The method of claim 11, further comprising:
determining a number of monitored viewers turning their head in a direction towards a main portion of the second camera field of view or away from the main portion of the second camera field of view.

13. The method of claim 11,
wherein making the camera switch recommendation includes:
i) making a decision to recommend a switch to said second camera in response to determining that the majority of monitored viewers are turning their head toward the main portion of the second camera field of view; and
ii) making a decision not to recommend a switch to said second camera in response to determining that the majority of monitored viewers are turning their head away from the main portion of the second camera field of view.

14. A system comprising:
a receiver for receiving image content captured by at least first and second cameras in an environment;
a control apparatus including a processor configured to:
perform a monitoring operation, said monitoring operation including at least one of:
i) determining a location of an object of interest in an environment; or
ii) tracking where at least one viewer is looking in said environment; and
generate a camera switch recommendation based on information obtained by said monitoring operation; and
present the camera switch recommendation to an operator of said control apparatus or automatically implement the generated camera switch recommendation.

15. The system of claim 14,
wherein said processor is further configured, as part of said monitoring operation, to determine the location of the object of interest; and
wherein said processor is further configured to determine if the object of interest is in a field of view of a second camera in addition to being in a field of view of said first camera; and
wherein the processor is also further configured, as part of generating the camera switch recommendation, to make a decision to recommend a switch to said second camera or a recommendation not to switch to said second camera based on whether the object of interest is determined to be in the field of view of the second camera in addition to being in the field of view of said first camera or is determined not be in the field of view of a second camera in addition to being in said field of view of said first camera.

16. The system of claim 15, wherein said processor is further configured, as part of performing the monitoring operation, to:
determine a direction of motion of the object of interest.

17. The system of claim 16, wherein generating the camera switch recommendation is further based on the direction of motion of the object of interest.

18. The system of claim 17, wherein the processor is further configured, as part of generating the camera switch recommendation, to:
i) make a decision to recommend a switch to said second camera in response to determining that the object of interest is in the field of view of both said first and second cameras and is moving in a direction of motion out of said field of view of the first camera but which will remain in the field of view of the second camera upon exiting the field of view of the first camera; and
ii) make a decision to recommend not to switch to said second camera in response to determining that the object of interest is in the field of view of both said first and second cameras and is moving in a direction of motion towards a main portion of the field of view of the first camera.

19. The system of claim 18, wherein the processor is further configured to:
automatically implement the generated camera switch recommendation when said decision is a decision to recommend a switch to said second camera and the object of interest is about to move out of said field of view of the first camera but will remain in the field of view of the second camera upon exiting the field of view of the first camera.

20. A non-transitory computer readable medium including computer executable instructions, which when executed by a processor of a system, control the system to perform the steps of:
performing a monitoring operation, said monitoring operation including at least one of:
i) determining a location of an object of interest in an environment; or
ii) tracking where at least one viewer is looking in said environment;
generating a camera switch recommendation based on information obtained by said monitoring operation; and
presenting the camera switch recommendation to an operator of said system or automatically implementing the generated camera switch recommendation.
